(19) United States
(12) Patent Application Publication
(10) Pub. No.: US 2017/0045668 A1
(43) Pub. Date: Feb. 16, 2017

(54) LIGHT EXTRACTING ELEMENT HAVING SERPENTINE SHAPE, LIGHT REDIRECTING ELEMENT HAVING SERPENTINE SHAPE, AND LIGHTING ASSEMBLY INCLUDING THE SAME

(71) Applicant: Rambus Delaware LLC, Sunnyvale, CA (US)

(72) Inventors: Greg Coghlan, Olmsted Falls, OH (US); Todd Winski, Hudson, OH (US)

(21) Appl. No.: 15/236,734

(22) Filed: Aug. 15, 2016

Related U.S. Application Data
(60) Provisional application No. 62/205,066, filed on Aug. 14, 2015.

(51) Int. Cl. F21V 8/00

(52) U.S. Cl. CPC G02B 6/0036; G02B 6/0038; G02B 6/0058; G02B 6/005

(57) ABSTRACT

A light guide includes opposed major surfaces, a light input edge extending therebetween, and light extracting elements at at least one of the major surfaces. At least a portion of the light extracting elements includes: a longitudinal axis extending between a first end and a second end of the light extracting element; a first side surface and a second side surface each extending from the major surface; and a ridge or end surface connecting the first side surface and the second side surface, the ridge or end surface extending along the longitudinal axis in a non-linear, winding path as viewed from a direction orthogonal to the major surface. In some embodiments, a cover element includes light redirecting elements having a ridge or end surface extending along a longitudinal axis of the element in a non-linear, winding path as viewed from a direction orthogonal to the major surface.

### RELATED APPLICATION DATA

This application claims the benefit of U.S. Provisional Patent Application No. 62/205,066, filed Aug. 14, 2015, the disclosure of which is incorporated herein by reference in its entirety.

### BACKGROUND

Energy efficiency has become an area of interest for energy consuming devices. One class of energy consuming devices is lighting devices. Light emitting diodes (LEDs) show promise as energy efficient light sources for lighting devices. For some LED-based lighting assemblies, the light emitted from the light source is input to a light guide and light extracting elements specularly extract the light from the light guide in a defined direction. A cover element may also be used to redirect light extracted from the light guide. But visual artifacts may appear at the major surface(s) of the illuminated lighting assembly and can present an issue. Control over light output distribution can also be an issue for lighting devices that use LEDs or similar light sources.

### BRIEF DESCRIPTION OF THE DRAWINGS

FIG. 1 is a schematic perspective view of an exemplary lighting assembly.

FIG. 2 is a schematic top view of an exemplary micro-optical element.

FIGS. 3 and 4 are schematic cross-sectional views of the exemplary micro-optical element of FIG. 2.

FIG. 5 is a schematic top view of an exemplary micro-optical element.

FIGS. 6 and 7 are schematic cross-sectional views of the exemplary micro-optical element of FIG. 5.

FIGS. 8 and 9 are scanning electron microscope (SEM) images of exemplary micro-optical elements.

FIG. 10 is a schematic top view of an exemplary micro-optical element.

FIGS. 11 and 12 are schematic cross-sectional views of the exemplary micro-optical element of FIG. 10.

FIG. 13 is a schematic top view of an exemplary micro-optical element.

FIGS. 14 and 15 are schematic cross-sectional views of the exemplary micro-optical element of FIG. 13.

FIG. 16 is a schematic top view of an exemplary micro-optical element.

FIGS. 17 and 18 are schematic cross-sectional views of the exemplary micro-optical element of FIG. 16.

FIG. 19 is a schematic top view of an exemplary lighting assembly.

FIGS. 20-22 are schematic cross-sectional views of exemplary light extracting elements.

FIG. 23 is an SEM image of exemplary micro-optical elements.

FIG. 24 is a schematic top view of an exemplary lighting assembly.

FIG. 25 is an SEM image of exemplary micro-optical elements.

FIGS. 26 and 27 are schematic top views of exemplary lighting assemblies.

FIGS. 28 and 29 are photographs showing a visual effect of light emitted from exemplary lighting assemblies.

FIG. 30 is a graph showing light output distribution profiles of exemplary lighting assemblies.

FIG. 31 is a schematic side view of an exemplary lighting assembly.

FIG. 32 is a schematic top view of an exemplary cover element.

### DESCRIPTION

Embodiments will now be described with reference to the drawings, wherein like reference numerals are used to refer to like elements throughout. The figures are not necessarily to scale. Features that are described and/or illustrated with respect to one embodiment may be used in the same way or in a similar way in one or more other embodiments and/or in combination with or instead of the features of the other embodiments. In this disclosure, angles of incidence, reflection, and refraction and output angles are measured relative to the normal to the surface (e.g., the major surface).

In accordance with one aspect of the present disclosure, a light guide includes: a first major surface; a second major surface opposed the first major surface; a light input edge extending between the first major surface and the second major surface, the first major surface and the second major surface configured to propagate light input to the light guide through the light input edge therebetween by total internal reflection; and light extracting elements at at least one of the major surfaces, at least a portion of the light extracting elements including: a longitudinal axis extending between a first end and a second end of the light extracting element; a first side surface and a second side surface each extending from the major surface of the light guide at which the light extracting element is formed; and a ridge or end surface connecting the first side surface and the second side surface, the ridge or end surface extending along the longitudinal axis in a non-linear, winding path as viewed from a direction orthogonal to the major surface of the light guide at which the light extracting element is formed.

In accordance with another aspect of the present disclosure, a micro-optical element formed at a major surface of a light guide includes: a longitudinal axis extending between a first end and a second end of the micro-optical element; a first side surface and a second side surface each extending from the major surface of the light guide at which the micro-optical element is formed; and a ridge or end surface connecting the first side surface and the second side surface, the ridge or end surface having ends that respectively intersect the major surface of the light guide at the first end and the second end of the micro-optical element, the ridge or end surface extending along the longitudinal axis in a non-linear, winding path as viewed from a direction orthogonal to the major surface of the light guide at which the light extracting element is formed.

In accordance with another aspect of the present disclosure, a lighting assembly includes: a light guide having opposed first and second major surfaces between which light propagates by total internal reflection, the light guide including light extracting elements configured to output light from the light guide; and a cover element adjacent to one of the major surfaces of the light guide and configured to redirect light output from the light guide, the cover element including: a first major surface; a second major surface opposed to the first major surface; and light redirecting elements at at least one of the major surfaces of the cover element, at least a portion of the light redirecting elements including: a longitudinal axis extending between a first end and a second end of the light redirecting element; a first side surface and a second side surface each extending from the major surface of the cover element at which the light redirecting element is formed; and a ridge or end surface connecting the first side surface and the second side surface, the ridge or end surface extending along the longitudinal axis in a non-linear, winding path as viewed from a direction orthogonal to the major surface of the cover element at which the light redirecting element is formed.

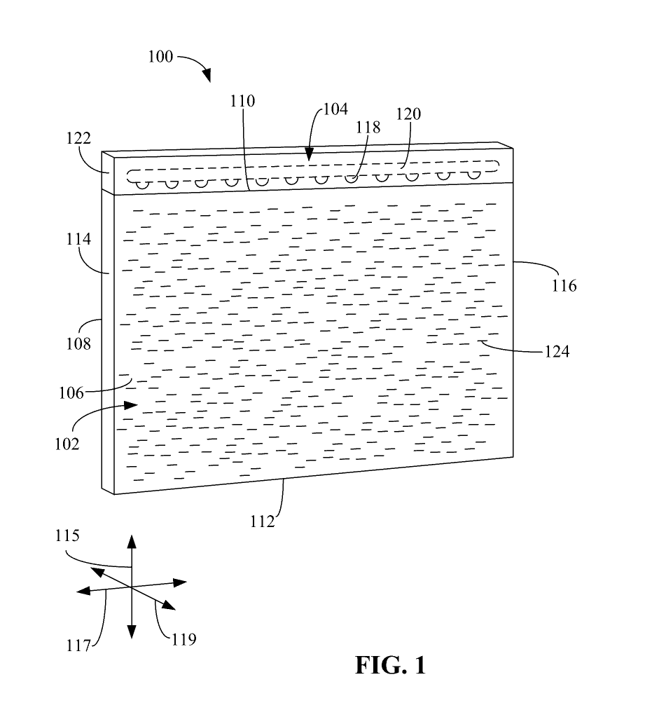

With initial reference to FIG. 1, an exemplary embodiment of a lighting assembly is shown at 100. The lighting assembly 100 includes a light guide 102. The light guide 102 is a solid article of manufacture (e.g., a substrate) made from, for example, polycarbonate, poly(methyl-methacrylate) (PMMA), glass, or other appropriate material. The light guide 102 may also be a multi-layer light guide having two or more layers that may differ in refractive index. The light guide 102 includes a first major surface 106 and a second major surface 108 opposite the first major surface 106. The light guide 102 is configured to propagate light by total internal reflection between the first major surface 106 and the second major surface 108. The length and width dimensions of each of the major surfaces 106, 108 are greater, typically ten or more times greater, than the thickness of the light guide 102. The thickness is the dimension of the light guide 102 in a direction orthogonal to the major surfaces 106, 108 (i.e., thickness direction 119). The thickness of the light guide 102 may be, for example, about 0.1 millimeters (mm) to about 10 mm.

At least one edge surface extends between the major surfaces 106, 108 of the light guide in the thickness direction. The total number of edge surfaces depends on the configuration of the light guide. In the case where the light guide is rectangular, the light guide has four edge surfaces 110, 112, 114, 116. In the embodiment shown, the light guide extends in a first direction 115 between edge surface 110 and edge surface 112; and extends in a second direction 117 orthogonal to the first direction 115 between edge surface 114 and edge surface 116. Other light guide shapes result in a corresponding number of side edges. Although not shown, in some embodiments, the light guide 102 may additionally include one or more edge surfaces defined by the perimeter of an orifice extending through the light guide in the thickness direction. Each edge surface defined by the perimeter of an orifice extending through the light guide 102 will hereinafter be referred to as an internal edge surface. Depending on the shape of the light guide 102, each edge surface may be straight or curved, and adjacent edge surfaces may meet at a vertex or join in a curve. Moreover, each edge surface may include one or more straight portions connected to one or more curved portions. The edge surface through which light from the light source 104 is input to the light guide will now be referred to as a light input edge. In the embodiment shown in FIG. 1, the edge surface 110 is a light input edge. In some embodiments, the light guide 102 includes more than one light input edge. For example, a light source may also be present at the edge surface 112 opposite the edge surface 110. Furthermore, the one or more light input edges may be straight and/or curved.

In the embodiment shown in FIG. 1, the major surfaces 106, 108 are planar. In other embodiments, at least a portion of the major surfaces 106, 108 of the light guide 102 is curved in one or more directions. In one example, the intersection of the light input edge 110 and one of the major surfaces 106, 108 defines a first axis, and at least a portion of the light guide 102 curves about an axis parallel to the first axis. In another example, at least a portion of the light guide 102 curves about an axis orthogonal to the first axis. Other exemplary shapes of the light guide include a semi-cylindrical body, a dome, a hollow cylinder, a hollow cone or pyramid, a hollow frustrated cone or pyramid, a bell shape, an hourglass shape, or another suitable shape.

With continued reference to FIG. 1, the lighting assembly 100 includes a light source 104 positioned adjacent the light input edge 110. The light source 104 is configured to edge light the light guide 102 such that light from the light source 104 enters the light input edge 110 and propagates along the light guide 102 by total internal reflection at the major surfaces 106, 108. In embodiments where the light guide includes more than one light input edge, the lighting assembly 100 may include a corresponding number of light sources 104.

The light source 104 may include one or more solid-state light emitters 118. The solid-state light emitters 118 constituting the light source 104 are arranged linearly or in another suitable pattern depending on the shape of the light input edge of the light guide 102 to which the light source 104 supplies light. Exemplary solid-state light emitters 118 include such devices as LEDs, laser diodes, and organic LEDs (OLEDs). In an embodiment where the solid-state light emitters 118 are LEDs, the LEDs may be top-fire LEDs or side-fire LEDs, and may be broad spectrum LEDs (e.g., white light emitters) or LEDs that emit light of a desired color or spectrum (e.g., red light, green light, blue light, or ultraviolet light), or a mixture of broad-spectrum LEDs and LEDs that emit narrow-band light of a desired color. In one embodiment, the solid-state light emitters 118 emit light with no operably-effective intensity at wavelengths greater than 500 nanometers (nm) (i.e., the solid-state light emitters 118 emit light at wavelengths that are predominantly less than 500 nm). In some embodiments, the solid-state light emitters 118 constituting light source 104 all generate light having the same nominal spectrum. In other embodiments, at least some of the solid-state light emitters 118 constituting light source 104 generate light that differs in spectrum from the light generated by the remaining solid-state light emitters 118. For example, two different types of solid-state light emitters 118 may be alternately located along the light source 104.

The lighting assembly 100 may include one or more additional components. For example, although not specifically shown in detail, in some embodiments of the lighting assembly, the light source 104 includes structural components to retain the solid-state light emitters 118. In the example shown in FIG. 1, the solid-state light emitters 118 may be mounted to a printed circuit board (PCB) 120. The light source 104 may additionally include circuitry, power supply, electronics for controlling and driving the solid-state light emitters 118, and/or any other appropriate components. The lighting assembly 100 may include a housing 122 for retaining the light source 104 and the light guide 102. The housing 122 may retain a heat sink or may itself function as a heat sink. In some embodiments, the lighting assembly 100 includes a mounting mechanism (not shown) to mount the lighting assembly to a retaining structure (e.g., a ceiling, a wall, etc.). The lighting assembly 100 may include a reflector (not shown) adjacent one of the major surfaces 106, 108. The reflector may be a specular reflector, a diffuse reflector, or a patterned reflector. The light extracted through the major surface adjacent the reflector may be reflected by the reflector, re-enter the light guide 102 at the major surface, and be output from the light guide 102 through the other major surface.

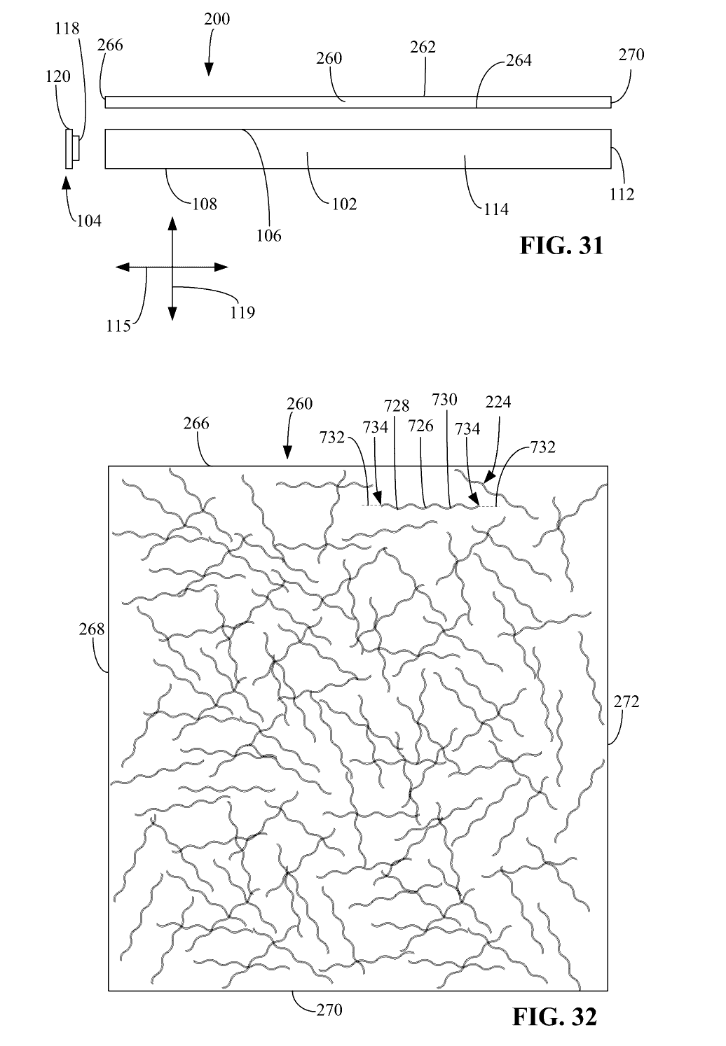

In some embodiments, the lighting assembly 100 may include a cover element adjacent one of the major surfaces 106, 108. An exemplary cover element is described below with respect to FIGS. 31 and 32 in the context of lighting assembly 200. The light extracted through the major surface of the light guide adjacent the cover element may pass through the cover element and may be redirected. The cover element may be a solid article of manufacture (e.g., a substrate) made from, for example, polycarbonate, poly(methyl-methacrylate) (PMMA), glass, or other appropriate material; and may include a first major surface and a second major surface opposite the first major surface. A major surface of the cover element may be located adjacent one of the major surfaces 106, 108 of the light guide 102. The cover element may include light redirecting elements (e.g., similar to the light extracting elements described below) at at least one of its major surfaces configured to redirect light passed therethrough.

With continued reference to FIG. 1, the light guide 102 includes light extracting elements 124 in, on, or beneath at least one of the major surfaces 106, 108. Light extracting elements that are in, on, or beneath a major surface will be referred to as being “at” the major surface. In FIG. 1, the light extracting elements 124 are generically shown as being at the first major surface 106. While the light extracting elements 124 are generically shown in FIG. 1 as dashes, it will be understood that the light extracting elements can respectively have one or more specific configurations, such as those described below.

Each light extracting element 124 functions to disrupt the total internal reflection of the light propagating in the light guide and incident thereon. In one embodiment, the light extracting elements 124 reflect light toward the opposing major surface so that the light exits the light guide 102 through the opposing major surface. Alternatively, the light extracting elements 124 transmit light through the light extracting elements 124 and out of the major surface of the light guide 102 having the light extracting elements 124. In another embodiment, both types of light extracting elements 124 are present. In yet another embodiment, the light extracting elements 124 reflect some of the light and refract the remainder of the light incident thereon, and therefore the light extracting elements 124 are configured to extract light from the light guide 102 through one or both of the major surfaces 106, 108.

Exemplary light extracting elements 124 include features of well-defined shape, such as grooves (e.g., V-grooves and/or truncated V-grooves) that are recessed into or protrude from the major surface. Other exemplary light extracting elements 124 include micro-optical elements, which are features of well-defined shape that are small relative to the linear dimensions of the major surfaces 106, 108. The smaller of the length and width of a micro-optical element is less than one-tenth of the longer of the length and width (or circumference) of the light guide 102 and the larger of the length and width of the micro-optical element is less than one-half of the smaller of the length and width (or circumference) of the light guide 102. The length and width of the micro-optical element is measured in a plane parallel to the major surface 106, 108 of the light guide 102 for planar light guides or along a surface contour for non-planar light guides 102. The reference numeral 124 will be generally used to collectively refer to the different embodiments of light extracting elements.

Light extracting elements 124 of well-defined shape (e.g., the above-described grooves and micro-optical elements) are shaped to predictably reflect and/or refract the light propagating in the light guide 102. In some embodiments, at least one of the light extracting elements 124 is an indentation (depression) of well-defined shape in the major surface 106, 108. In other embodiments, at least one of the light extracting elements 124 is a protrusion of well-defined shape from the major surface 106, 108. The light extracting elements of well-defined shape have distinct surfaces on a scale larger than the surface roughness of the major surfaces 106, 108. Light extracting elements of well-defined shape exclude features of indistinct shape or surface textures, such as printed features of indistinct shape, ink-jet printed features of indistinct shape, selectively-deposited features of indistinct shape, and features of indistinct shape wholly formed by chemical etching or laser etching.

The light extracting elements 124 are configured to extract light in a defined intensity profile (e.g., a uniform intensity profile) and with a defined light ray angle distribution from one or both of the major surfaces 106, 108. In this disclosure, intensity profile refers to the variation of intensity with regard to position within a light-emitting region (such as the major surface or a light output region of the major surface). The term light ray angle distribution is used to describe the variation of the intensity of light with ray angle (typically a solid angle) over a defined range of light ray angles. In an example in which the light is emitted from an edge-lit light guide, the light ray angles can range from −90° to +90° relative to the normal to the major surface. Each light extracting element 124 of well defined shape includes at least one surface configured to refract and/or reflect light propagating in the light guide 102 and incident thereon such that the light is extracted from the light guide. Such surface(s) is also herein referred to as a light-redirecting surface.

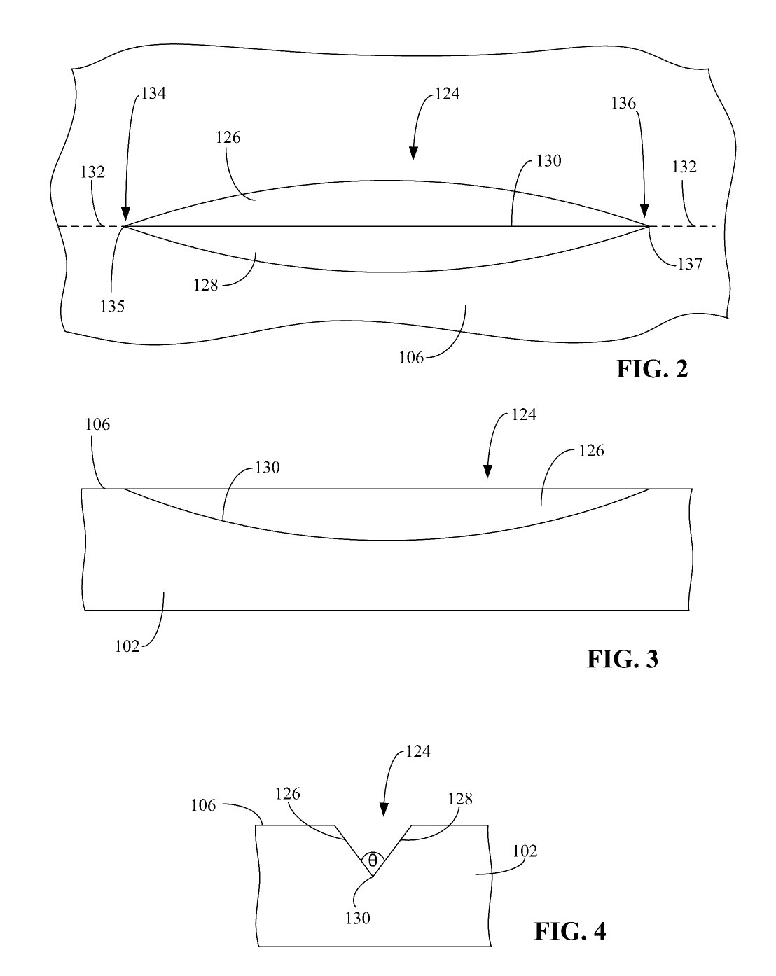

FIGS. 2-4 show an exemplary micro-optical element that is hereinafter referred to as a “football-shaped” micro-optical element. A football-shaped micro-optical element resembles the profile of the ball used in American football. The exemplary football-shaped micro-optical element is shown as a v-shaped depression in the major surface 106 having a ridge that is arcuate in the thickness direction as viewed from a direction orthogonal to the thickness direction and orthogonal to the longitudinal axis of the micro-optical element (shown in FIG. 3); and that extends linearly as viewed from a direction orthogonal to the major surface at which the light extracting element is formed between the first end 134 and the second end 136 of the micro-optical element (shown in FIG. 2). The football-shaped micro-optical element 124 includes a longitudinal axis 132 extending between a first end 134 and a second end 136 of the light extracting element. FIG. 2 shows a top view of the exemplary micro-optical element 124 as viewed from a direction orthogonal to the major surface 106. FIG. 3 shows a side cross-sectional view of the exemplary micro-optical element 124 with the longitudinal axis of the micro-optical element parallel to the plane of the page. FIG. 4 shows a side cross-sectional view of the exemplary micro-optical element with the longitudinal axis of the micro-optical element normal to the plane of the page.

The football-shaped micro-optical element 124 includes a first side surface 126 and a second side surface 128 each extending from the major surface. The first side surface 126 and a second side surface 128 come together (intersect) to form the ridge 130. The ridge 130 has ends 135, 137 that respectively intersect the major surface at which the micro-optical element is formed at the first end 134 and the second end 136 of the micro-optical element. As shown, the ridge is linear and extends parallel to the longitudinal axis 132 of the micro-optical element as viewed from a direction orthogonal to the major surface 106 (FIG. 2).

Other exemplary light extracting elements 124 may have other suitable shapes. Exemplary micro-optical elements are described in U.S. Pat. No. 6,752,505, the entire content of which is incorporated by reference, and, for the sake of brevity, are not described in detail in this disclosure.

The longitudinal axis 132 of a light extracting element may be defined by one of the length or width of the light extracting element in the plane of the major surface 106, 108 of the light guide 102. At least a portion of the light extracting elements 124 each include a longitudinal axis 132. The longitudinal axis 132 is distinguishable from other axes of the light extracting element extending in a plane parallel to the major surface 106, 108 of the light guide 102 for planar light guides or along a surface contour for non-planar light guides 102. In some embodiments, all of the light extracting elements 124 include a longitudinal axis 132. In other embodiments, some light extracting elements (e.g., a conical or frustoconical micro-optical element having a circular base) may not have a distinguishable longitudinal axis. In some embodiments, the longitudinal axis 132 of the light extracting element 124 may be arranged closer to parallel to the light input edge than an axis extending perpendicular to the longitudinal axis. As an example, the longitudinal axis of some or of all of the micro-optical elements may be arranged parallel to the light input edge 110. In other embodiments, the longitudinal axis of some or of all the micro-optical elements may be respectively arranged within a range of angles relative to the light input edge 110 (e.g., within a range of ±45° relative to the light input edge).

Light extracting elements 124 of well-defined shape may provide specular light extraction from the light guide in a defined intensity profile and with a defined light ray angle distribution. But this specular light extraction may also provide an optically-specular path extending into the light guide from the light input edge. As a result, the surfaces of the light guide including the light extracting elements create an imaging path back to the light source, and reflections of the light source as viewed through the optically-specular path are visible to a viewer viewing the lighting assembly. The discrete solid-state light emitters of the light source may create visual artifacts due to imaging of the light source. Accordingly, even if the light extracting elements are arranged to extract light in a uniform intensity profile over the major surface, the optically-specular path creates the visual effect of one or more relatively high-intensity areas of light at the surface of the light guide. As an example, the relatively high-intensity areas of light may be shown as one or more columns of light extending along the light guide from the light input edge, also referred to as a “headlighting” effect. As another example, the relatively high-intensity areas of light may be shown as one or more bands of light extending in the width direction of the light guide (e.g., relatively parallel to the light input edge), also referred to as a “banding” effect.

Moreover, undesirable visual effects can occur due to the preservation of the output angle of light at a major surface of the light guide for different respective wavelengths of light propagating in the light guide that are incident and extracted by the light extracting element. This can lead to the appearance of color splitting among the light output from the light guide.

While the headlighting effect, banding effect, and/or the appearance of color splitting can be reduced by one or more optical adjusters (not shown) (e.g., a diffusing film) located adjacent one or both of the major surfaces 106, 108, the use of the optical adjusters for such purpose destroys the directional, specular light output distribution of the light output from the lighting assembly. The use of the optical adjusters also lowers the efficiency of the lighting assembly. Furthermore, in some applications (e.g., as a lighting fixture, a sign, a display apparatus, etc.), the use of an optical adjuster is not preferable (e.g., for aesthetic reasons). In addition, the use of an optical adjuster adds cost to the lighting assembly.

In accordance with the present disclosure, one or more of the light extracting elements may be provided as serpentine-shaped light extracting elements. The light extracting elements of the present disclosure are referred to herein as “serpentine-shaped” because at least a portion of the ridge or end surface extending along the longitudinal axis between the first end and the second of the light extracting element extends in a non-linear, winding path as viewed from a direction orthogonal to the major surface at which the light extracting element is formed (e.g., as viewed from a perspective parallel to the thickness direction 119). In some embodiments, the ridge or surface may undulate as viewed from a direction orthogonal to the major surface. For example, in some embodiments, the ridge or end surface is provided in a sinusoidal path such that it oscillates in a sinusoidal pattern as viewed from a direction orthogonal to the major surface. In an example, the ridge or end surface may oscillate in a sinusoidal pattern with a given period (frequency) and amplitude that is nominally constant and uniform from the first end to the second end of the light extracting element. The term “nominally” as used herein encompasses variations of one or more parameters that fall within acceptable tolerances in design and/or manufacture. In another example, the oscillation may vary in one or both of period (frequency) and amplitude between the first end and the second end of the light extracting element. For example, the oscillation may increase and/or decrease in one or both of period (frequency) and amplitude. In still another example, the ridge or end surface may oscillate in a sinusoidal pattern for a portion of the distance between the first end and the second end of the micro-optical element, while one or more other portions between the first end and the second end of the micro-optical element may be linear. Hence, the ridge or end surface may be partially sinusoidal and partially linear, pseudo-random, or any other suitable shape.

The serpentine-shaped light extracting elements may be included in the array of light extracting elements provided at the major surface(s) of the light guide. A portion or all of the light extracting elements at the major surface(s) may be serpentine-shaped light extracting elements. The presence of the sepentine-shaped light extracting elements in the array may reduce undesired visual effects at the major surface of the light guide. The sepentine-shaped light extracting elements may also largely maintain the directional, specular light output distribution of the light output from the lighting assembly.

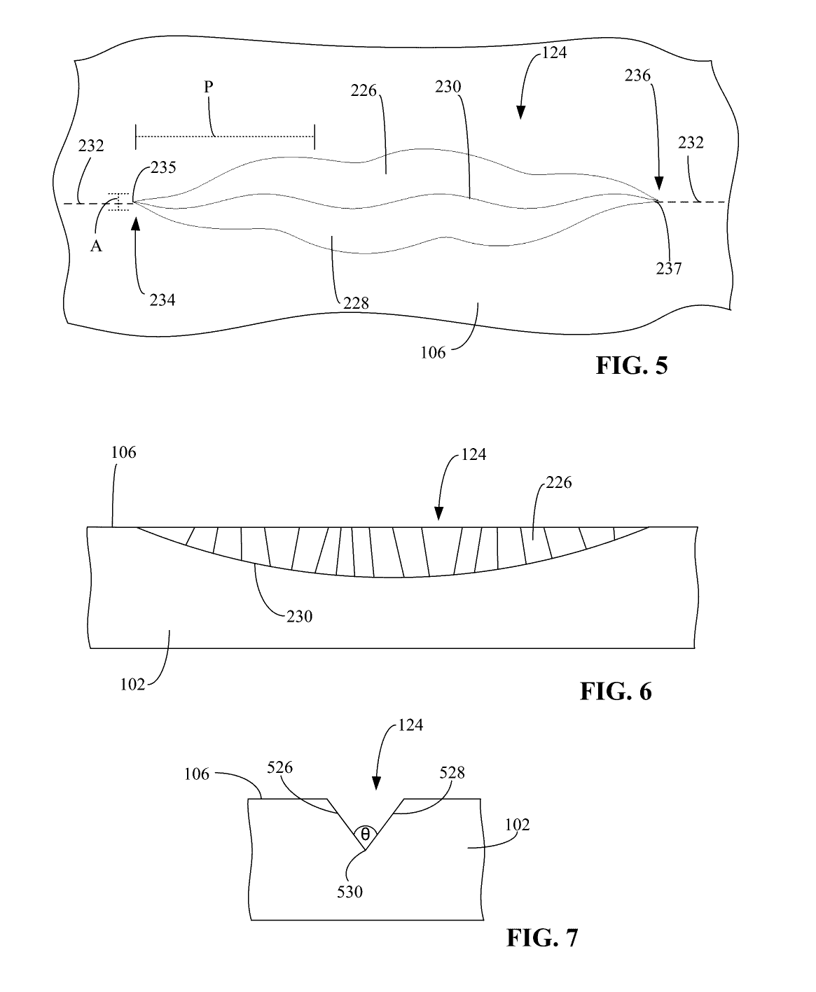

FIGS. 5-7 show one exemplary embodiment of a serpentine-shaped light extracting element. In this exemplary embodiment, the element is embodied as a micro-optical element. FIG. 5 shows a top view of the micro-optical element as viewed from a direction orthogonal to the major surface 106. FIG. 6 shows a side cross-sectional view of the micro-optical element with the longitudinal axis of the micro-optical element parallel to the plane of the page. FIG. 7 shows a side cross-sectional view of the micro-optical element with the longitudinal axis of the micro-optical element normal to the plane of the page.

The exemplary serpentine-shaped micro-optical element is shown as a v-shaped depression in the major surface having a ridge 230 that is arcuate as viewed from a direction orthogonal to the thickness direction of the light guide and orthogonal to the longitudinal axis of the micro-optical element (shown in FIG. 6); and that extends in a non-linear, winding path as viewed from a direction orthogonal to the major surface at which the light extracting element is formed between the first end 234 and the second end 236 of the micro-optical element (shown in FIG. 5). The serpentine-shaped micro-optical element 124 includes a first side surface 226 and a second side surface 228 that each extend from the major surface at which the micro-optical element is formed, and that come together (intersect) to form the ridge 230. The ridge 230 has ends 235, 237 that respectively intersect the major surface at which the micro-optical element is formed at the first end 234 and the second end 236 of the micro-optical element. The longitudinal axis 232 of the serpentine-shaped micro-optical element extends between the first end 234 and the second end 236 of the micro-optical element.

The included angle θ (see FIG. 7) formed between the first side surface 226 and the second side surface 228 may be any suitable angle, and may be set for extracting light from the light guide 102 at a defined intensity profile and/or light ray angle distribution. As an example, the included angle θ may range from 30 degrees to 165 degrees. In some embodiments, the first side surface 226 and the second side surface 228 are symmetric relative to a plane extending parallel to the longitudinal axis 232 and extending normal to the major surface. In other embodiments, the first side surface 226 and the second side surface 228 are asymmetric relative to a plane extending parallel to the longitudinal axis 232 and extending normal to the major surface.

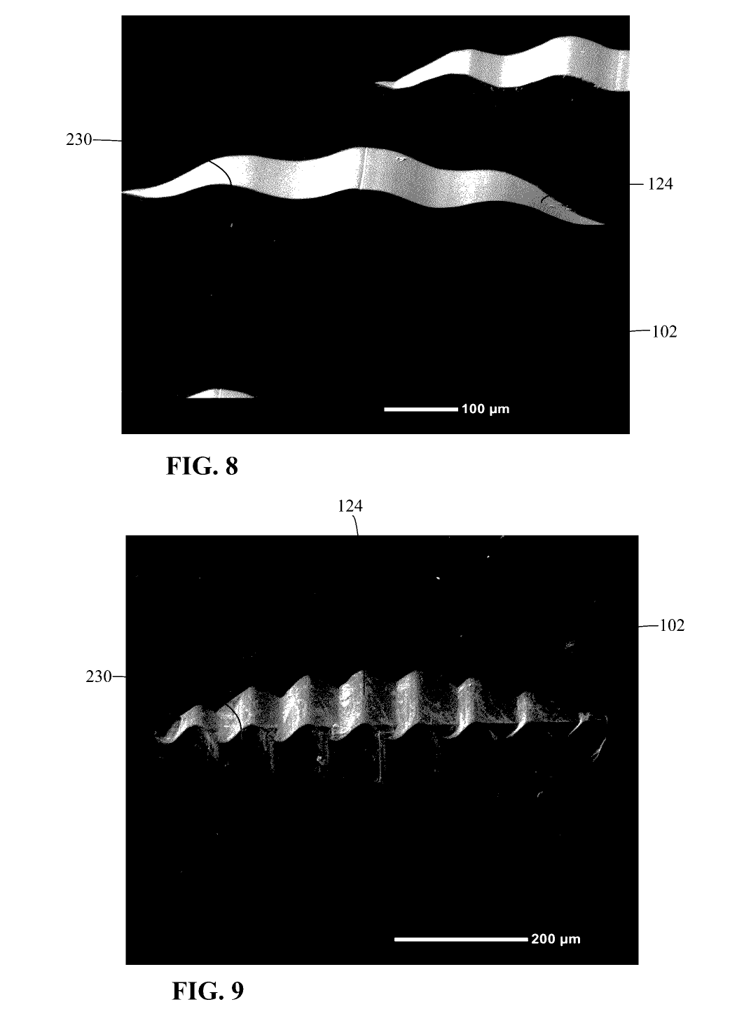

The ridge 230 extends along the longitudinal axis 232 between the first end 234 and the second end 236 of the micro-optical element. As shown in FIG. 5 from the top view of the exemplary micro-optical element 124, as viewed from a direction orthogonal to the major surface at which the light extracting element is formed, the ridge 230 oscillates in a sinusoidal pattern with a given period P (frequency) and amplitude A between the first end 234 and the second end 236 of the micro-optical element. As a result of the oscillation of the ridge 230, the first side surface 226 and the second side surface 228 are also non-planar surfaces, with their specific shape corresponding to the shape (e.g., oscillation) of the ridge. As shown in the example, the first side surface 226 and the second side surface 228 are provided as undulating surfaces (e.g., a wave shape). The contour of the undulating surface is schematically illustrated by the lines shown on the second side surface 226 in FIG. 6, as well as in the SEM images of FIGS. 8 and 9.

The ridge 230 exemplified in FIGS. 5-7 is provided as a non-linear, winding path having three oscillations with a given amplitude A. In other embodiments, the period P (frequency) and/or the amplitude A at which the ridge oscillates may be set to any appropriate value. As an example, the overall length of the serpentine-shaped micro-optical element (e.g., the length between the first end 234 and the second end 236 of the micro-optical element) may be set to a value between about 500 μm and 1000 μm, and the period P (frequency) and the amplitude A may be set accordingly. In other embodiments, the overall length of the serpentine-shaped micro-optical element may be set to a larger or smaller value than between about 500 μm and 1000 μm. The micro-optical element may include a larger or smaller number of oscillations depending on its length and the value of the period P.

In some embodiments, the period P may range from about 10 μm to about 500 μm. In another example, the period P may range from about 50 μm to about 250 μm. In another example, the period P may range from about 75 μm to about 225 μm. If the period P is too large (too low of a frequency), the serpentine shape may not provide an effective reduction in one or more of the above-mentioned undesirable visual effects. If the period P is too low (too high a frequency), the shape may degrade the directional, specular light output distribution of the light output from the lighting assembly.

FIG. 8 shows an SEM image of an exemplary serpentine-shaped micro-optical element similar to that shown in FIG. 5. As shown, the micro-optical element is about 650 μm in length, with the ridge 230 having three oscillations each at about a period of 216.7 μm. FIG. 9 shows an SEM image of an exemplary serpentine-shaped micro-optical element having a smaller period (higher frequency) than that shown in FIG. 8. As shown, the micro-optical element is about 688 μm in length, with the ridge 230 having eight oscillations each at about a period of 86 μm. In another example (not shown), the micro-optical element is about 700 μm in length, with the ridge having five oscillations each at about a period of 140 μm.

In some embodiments, the amplitude A may range from about 1 μm to about 100 μm. In another example, the amplitude may range from about 5 μm to about 50 μm. In another example, the amplitude may range from about 10 μm to about 25 μm. If the amplitude A is too low, the serpentine shape may not provide an effective reduction in one or more of the above-mentioned undesirable visual effects. If the amplitude A is too high, the shape may degrade the directional, specular light output distribution of the light output from the lighting assembly. For the exemplary serpentine-shaped micro-optical element shown in the SEM image of FIG. 8, the amplitude is about 37.5 μm. For the exemplary serpentine-shaped micro-optical element shown in the SEM image of FIG. 9, the amplitude is about 12 μm. In the other example described above where the micro-optical element is about 700 μm in length with the ridge having five oscillations each at about a period of 140 μm, the amplitude may be about 20 μm.

It will be appreciated that the period P (frequency) and amplitude A selected for a given light extracting element may depend in part on one another. For example, a smaller period (higher frequency) may allow for the amplitude to be lower. Providing more oscillations may allow for a greater effect, which may therefore allow for the amplitude to be provided at a lower value. In another example, a larger period (lower frequency) may allow for the amplitude to be higher. Providing a higher amplitude may allow for a greater effect, which may allow for the number of oscillations to be provided at a lower number. In the examples mentioned above, the exemplary serpentine-shaped micro-optical element in FIG. 8 includes a higher period of 216.7 μm and a lower amplitude of about 37.5 μm. In the exemplary serpentine-shaped micro-optical element in FIG. 9, the period is lower at 86 μm and the amplitude is lower at 12 μm. In the other example mentioned, the period is 140 μm and the amplitude is 20 μm. Of course, it will be appreciated that in some embodiments the period and amplitude may still be selected to have a relatively high period and a relatively high amplitude; and/or may be selected to have a relatively low period and a relatively low period.

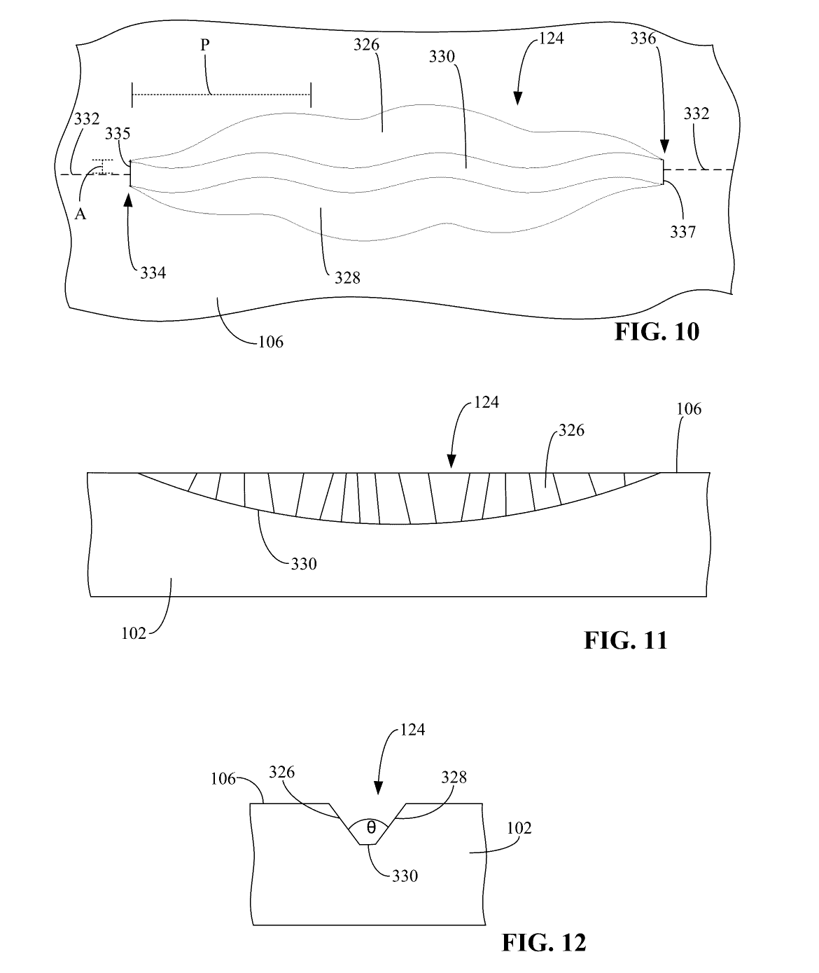

FIGS. 10-12 show another exemplary embodiment of a serpentine-shaped light extracting element. In this exemplary embodiment, the element is embodied as a micro-optical element. FIG. 10 shows a top view of the micro-optical element as viewed from a direction orthogonal to the major surface 106. FIG. 11 shows a side cross-sectional view of the micro-optical element with the longitudinal axis of the micro-optical element parallel to the plane of the page. FIG. 12 shows a side cross-sectional view of the micro-optical element with the longitudinal axis of the micro-optical element normal to the plane of the page.

The exemplary serpentine-shaped micro-optical element is shown as a truncated v-shaped depression in the major surface having an end surface 330 that is arcuate as viewed from a direction orthogonal to the thickness direction of the light guide and orthogonal to the longitudinal axis of the micro-optical element (shown in FIG. 11); and that extends in a non-linear, winding path as viewed from a direction orthogonal to the major surface at which the light extracting element is formed between the first end 334 and the second end 336 of the micro-optical element (shown in FIG. 10). Such shape is regarded as a “truncated” shape in that the shape includes an end surface 330 that joins the opposed side surfaces 326, 328 instead of a ridge. The serpentine-shaped micro-optical element 124 includes a first side surface 326 and a second side surface 328 that each extend from the major surface at which the micro-optical element is formed, and that are connected to each other by the end surface 330. The end surface 330 has ends 335, 337 that respectively intersect the major surface at which the micro-optical element is formed at the first end 334 and the second end 336 of the micro-optical element. The longitudinal axis 332 of the serpentine-shaped micro-optical element extends between the first end 334 and the second end 336 of the micro-optical element.

The exemplary serpentine-shaped light extracting element shown in FIGS. 10-12 differs from the exemplary serpentine-shaped light extracting element shown in FIGS. 5-7 in that the first side surface 326 and the second side surface 328 are joined by the end surface 330 instead of by a ridge. With specific reference to FIG. 12, when viewed in cross-section along the longitudinal axis and normal to the thickness direction, the end surface 330 is shown as a planar surface.

The included angle θ (see FIG. 12) formed between the first side surface 326 and the second side surface 328 may be any suitable angle, and may be set for extracting light from the light guide 102 at a defined intensity profile and/or light ray angle distribution. As an example, the included angle θ may range from 30 degrees to 165 degrees. In some embodiments, the first side surface 326 and the second side surface 328 are symmetric relative to a plane extending parallel to the longitudinal axis 332 and extending normal to the major surface. In other embodiments, the first side surface 326 and the second side surface 328 are asymmetric relative to a plane extending parallel to the longitudinal axis 332 and extending normal to the major surface.

The end surface 330 extends along the longitudinal axis 332 between the first end 334 and the second end 336 of the micro-optical element. As shown in FIG. 10 from the top view of the exemplary micro-optical element 124, as viewed from a direction orthogonal to the major surface at which the light extracting element is formed, the end surface 330 oscillates in a sinusoidal pattern with a given period P (frequency) and amplitude A between the first end 334 and the second end 336 of the micro-optical element. As a result of the oscillation of the end surface 330, the first side surface 326 and the second side surface 328 are also non-planar surfaces, with their specific shape corresponding to the shape (e.g., oscillation) of the end surface. As shown in the example, the first side surface 326 and the second side surface 328 are provided as undulating surfaces (e.g., a wave shape). This contour of the undulating surface is schematically illustrated by the lines shown on the second side surface 326 in FIG. 11.

The end surface 330 exemplified in FIGS. 10-12 is provided as a non-linear, winding path having three oscillations with a given amplitude A. In other embodiments, the period P (frequency) and/or the amplitude A at which the ridge oscillates may be set to any appropriate value. As an example, the overall length of the serpentine-shaped micro-optical element may be set to a value between about 500 μm and 1000 μm, and the period P (frequency) and the amplitude A may be set accordingly. In other embodiments, the overall length of the serpentine-shaped micro-optical element may be set to a larger or smaller value than between about 500 μm and 1000 μm. The micro-optical element may include a larger or smaller number of oscillations depending on its length and the value of the period P.

In some embodiments, the period P may range from about 10 μm to about 500 μm. In another example, the period P may range from about 50 μm to about 250 μm. In another example, the period P may range from about 75 μm to about 225 μm. If the period P is too large (too low of a frequency), the serpentine shape may not provide an effective reduction in one or more of the above-mentioned undesirable visual effects. If the period P is too low (too high a frequency), the shape may degrade the directional, specular light output distribution of the light output from the lighting assembly. In some embodiments, the amplitude A may range from about 1 μm to about 100 μm. In another example, the amplitude may range from about 5 μm to about 50 μm. In another example, the amplitude may range from about 10 μm to about 25 μm. If the amplitude A is too low, the serpentine shape may not provide an effective reduction in one or more of the above-mentioned undesirable visual effects. If the amplitude A is too high, the shape may degrade the directional, specular light output distribution of the light output from the lighting assembly. It will be appreciated that the period P (frequency) and amplitude A selected for a given light extracting element may depend in part on one another. For example, a smaller period (higher frequency) may allow for the amplitude to be lower. In another example, a larger period (lower frequency) may allow for the amplitude to be higher. Of course, it will be appreciated that in some embodiments the period and amplitude may still be selected to have a relatively high period and a relatively high amplitude; and/or may be selected to have a relatively low period and a relatively low period.

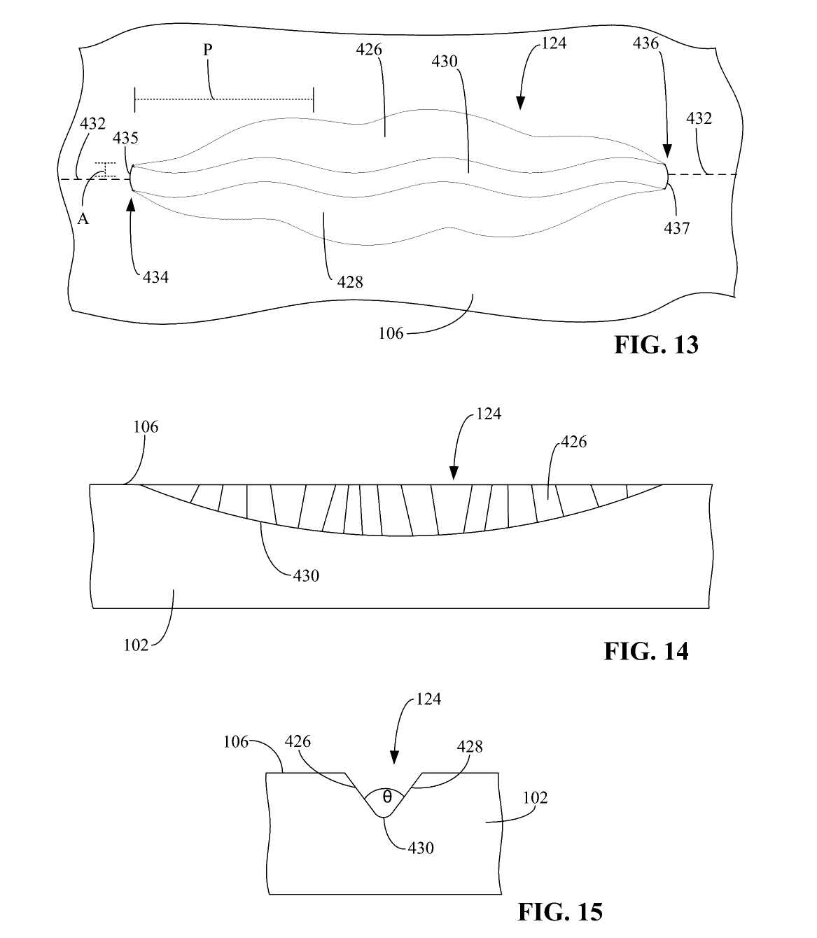

FIGS. 13-15 show another exemplary embodiment of a serpentine-shaped light extracting element. In this exemplary embodiment, the element is embodied as a micro-optical element. FIG. 13 shows a top view of the micro-optical element as viewed from a direction orthogonal to the major surface. FIG. 14 shows a side cross-sectional view of the micro-optical element with the longitudinal axis of the micro-optical element parallel to the plane of the page. FIG. 15 shows a side cross-sectional view of the micro-optical element with the longitudinal axis of the micro-optical element normal to the plane of the page.

The exemplary serpentine-shaped micro-optical element is shown as a truncated v-shaped depression in the major surface having an end surface 430 that is arcuate as viewed from a direction orthogonal to the thickness direction of the light guide and orthogonal to the longitudinal axis 432 (shown in FIG. 14), and that extends in a non-linear, winding path as viewed from a direction orthogonal to the major surface at which the light extracting element is formed between the first end 434 and the second end 436 of the micro-optical element (shown in FIG. 13). The serpentine-shaped micro-optical element 124 includes a first side surface 426 and a second side surface 428 that extend from the major surface at which the micro-optical element is formed, and that are connected to each other by the end surface 430. The end surface 430 has ends 435, 437 that respectively intersect the major surface at which the micro-optical element is formed at the first end 434 and the second end 436 of the micro-optical element. The longitudinal axis 432 of the serpentine-shaped micro-optical element extends between the first end 434 and the second end 436 of the micro-optical element.

The exemplary serpentine-shaped light extracting element shown in FIGS. 13-15 differs from the exemplary serpentine-shaped light extracting element shown in FIGS. 10-12 in that the end surface 430 joining the first side surface 426 and the second side surface 428, viewed in cross-section along the longitudinal axis and normal to the thickness direction (FIG. 15), is an arcuate surface instead of a planar surface.

The included angle θ (see FIG. 15) formed between the first side surface 426 and the second side surface 428 may be any suitable angle, and may be set for extracting light from the light guide 102 at a defined intensity profile and/or light ray angle distribution. As an example, the included angle θ may range from 30 degrees to 165 degrees. In some embodiments, the first side surface 426 and the second side surface 428 are symmetric relative to a plane extending parallel to the longitudinal axis 432 and extending normal to the major surface. In other embodiments, the first side surface 426 and the second side surface 428 are asymmetric relative to a plane extending parallel to the longitudinal axis 432 and extending normal to the major surface.

The end surface 430 extends along the longitudinal axis 432 between the first end 434 and the second end 436 of the micro-optical element. As shown in FIG. 13 from the top view of the exemplary micro-optical element 124, as viewed from a direction orthogonal to the major surface at which the light extracting element is formed, the end surface 430 oscillates in a sinusoidal pattern with a given period P (frequency) and amplitude A between the first end 434 and the second end 436 of the micro-optical element. As a result of the oscillation of the end surface 430, the first side surface 426 and the second side surface 428 are also non-planar surfaces, with their specific shape corresponding to the shape (e.g., oscillation) of the end surface. As shown in the example, the first side surface 426 and the second side surface 428 are provided as undulating surfaces (e.g., a wave shape). This contour of the undulating surface is schematically illustrated by the lines shown on the second side surface 426 in FIG. 14.

The end surface 430 shown in FIGS. 13-15 is provided as a non-linear, winding path having three oscillations with a given amplitude A. The period P (frequency) and/or the amplitude A at which the ridge oscillates may be set to any appropriate value. As an example, the overall length of the serpentine-shaped micro-optical element may be set to a value between about 500 μm and 1000 μm, and the period P (frequency) and the amplitude A may be set accordingly. In other embodiments, the overall length of the serpentine-shaped micro-optical element may be set to a larger or smaller value than between about 500 μm and 1000 μm. The micro-optical element may include a larger or smaller number of oscillations depending on its length and the value of the period P.

In some embodiments, the period P may range from about 10 μm to about 500 μm. In another example, the period P may range from about 50 μm to about 250 μm. In another example, the period P may range from about 75 μm to about 225 μm. If the period P is too large (too low of a frequency), the serpentine shape may not provide an effective reduction in one or more of the above-mentioned undesirable visual effects. If the period P is too low (too high a frequency), the shape may degrade the directional, specular light output distribution of the light output from the lighting assembly. In some embodiments, the amplitude A may range from about 1 μm to about 100 μm. In another example, the amplitude may range from about 5 μm to about 50 μm. In another example, the amplitude may range from about 10 μm to about 25 μm. If the amplitude A is too low, the serpentine shape may not provide an effective reduction in one or more of the above-mentioned undesirable visual effects. If the amplitude A is too high, the shape may degrade the directional, specular light output distribution of the light output from the lighting assembly. It will be appreciated that the period P (frequency) and amplitude A selected for a given light extracting element may depend in part on one another. For example, a smaller period (higher frequency) may allow for the amplitude to be lower. In another example, a larger period (lower frequency) may allow for the amplitude to be higher. Of course, it will be appreciated that in some embodiments the period and amplitude may still be selected to have a relatively high period and a relatively high amplitude; and/or may be selected to have a relatively low period and a relatively low period.

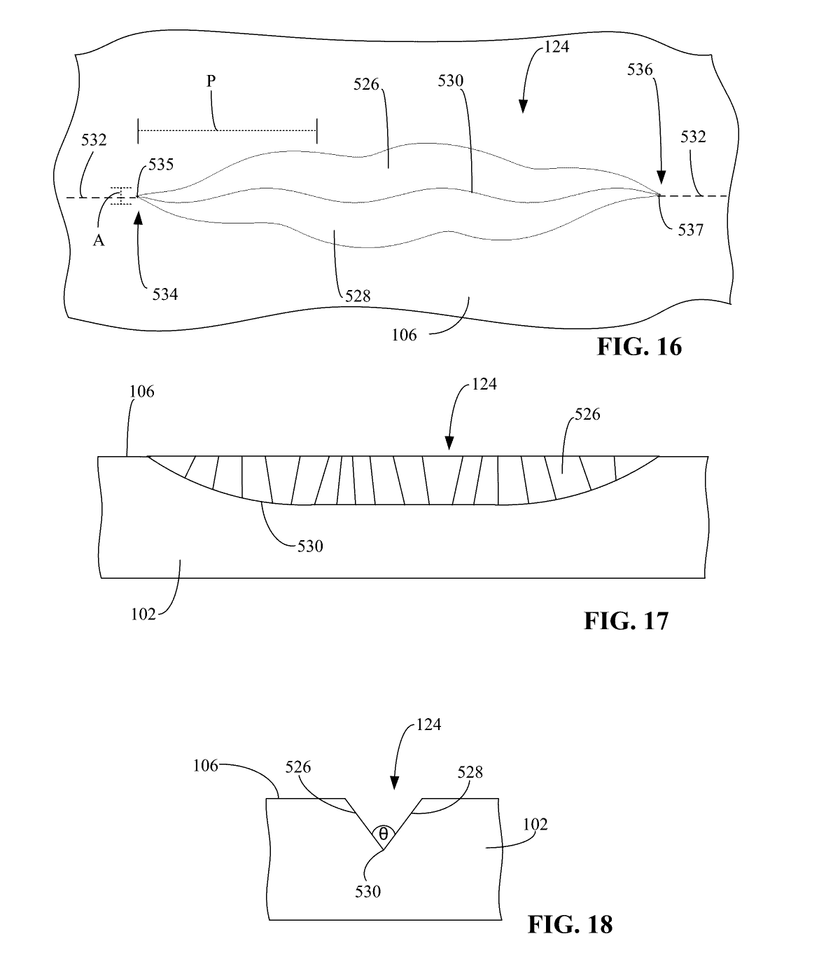

FIGS. 16-18 show another exemplary embodiment of a serpentine-shaped light extracting element. In this exemplary embodiment, the element is embodied as a micro-optical element. FIG. 16 shows a top view of the micro-optical element as viewed from a direction orthogonal to the major surface at which the light extracting element is formed. FIG. 17 shows a side cross-sectional view of the micro-optical element with the longitudinal axis of the micro-optical element parallel to the plane of the page. FIG. 18 shows a side cross-sectional view of the micro-optical element with the longitudinal axis of the micro-optical element normal to the plane of the page.

The exemplary serpentine-shaped micro-optical element is shown as a v-shaped depression in the major surface having a ridge 530 that is partially arcuate and partially linear as viewed from a direction orthogonal to the thickness direction of the light guide and orthogonal to the longitudinal axis 532 (shown in FIG. 17), and that extends in a non-linear, winding path as viewed from a direction orthogonal to the major surface at which the light extracting element is formed between the first end 534 and the second end 536 of the micro-optical element (shown in FIG. 16). The serpentine-shaped micro-optical element 124 includes a first side surface 526 and a second side surface 528 that each extend from the major surface at which the micro-optical element is formed, and that come together (intersect) to form the ridge 530. The ridge 530 has ends 535, 537 that respectively intersect the major surface at which the micro-optical element is formed at the first end 534 and the second end 536 of the micro-optical element. The longitudinal axis 532 of the serpentine-shaped micro-optical element extends between the first end 534 and the second end 536 of the micro-optical element.

The exemplary serpentine-shaped light extracting element shown in FIGS. 16-18 differs from the exemplary serpentine-shaped light extracting element shown in FIGS. 5-7 in that the ridge may include a non-uniform radius as viewed from a direction orthogonal to the thickness direction and orthogonal to the longitudinal axis 532. As shown in FIG. 17, the exemplary ridge includes a linear middle portion along its length in between two curved portions. A serpentine-shaped micro-optical element having this linear middle portion of the ridge may also be referred to as a dragged serpentine-shaped micro-optical element. This is contrasted with the ridge in FIGS. 5-7 that has a nominally uniform radius as viewed from a direction orthogonal to the thickness direction and orthogonal to the longitudinal axis. Although not specifically shown, other embodiments of the light extracting elements described above and shown in FIGS. 10-12 and 13-15 may also be formed as dragged serpentine-shaped micro-optical elements.

In still other embodiments, although not specifically shown, embodiments of the light extracting elements (e.g., such as those described above and shown in FIGS. 5-7, 10-12, 13-15, and 16-18) may have a ridge or end surface having another suitable configuration as viewed from a direction orthogonal to the thickness direction of the light guide and orthogonal to the longitudinal axis. As an example, at least a portion of the ridge or end surface as viewed from a direction orthogonal to the thickness direction and orthogonal to the longitudinal axis (e.g., as viewed in the direction shown in FIGS. 6, 11, 14, and 17) may extend in a non-linear, winding path. In some embodiments, the ridge or surface may undulate as viewed from a direction orthogonal to the thickness direction and orthogonal to the longitudinal axis. For example, in some embodiments, at least a portion of the ridge or end surface as viewed from a direction orthogonal to the thickness direction and orthogonal to the longitudinal axis may be provided in a sinusoidal path such that it oscillates in a sinusoidal pattern.

The included angle θ (see FIG. 18) formed between the first side surface 526 and the second side surface 528 may be any suitable angle, and may be set for extracting light from the light guide 102 at a defined intensity profile and/or light ray angle distribution. As an example, the included angle θ may range from 30 degrees to 165 degrees. In some embodiments, the first side surface 526 and the second side surface 528 are symmetric relative to a plane extending parallel to the longitudinal axis 532 and extending normal to the major surface. In other embodiments, the first side surface 526 and the second side surface 528 are asymmetric relative to a plane extending parallel to the longitudinal axis 532 and extending normal to the major surface.

The ridge 530 extends along the longitudinal axis 532 between the first end 534 and the second end 536 of the micro-optical element. As shown in FIG. 16 from the top view of the exemplary micro-optical element 124, as viewed from a direction orthogonal to the major surface at which the light extracting element is formed, the ridge 530 oscillates in a sinusoidal pattern with a given period P (frequency) and amplitude A between the first end 534 and the second end 536 of the micro-optical element. As a result of the oscillation of the ridge 530, the first side surface 526 and the second side surface 528 are also non-planar surfaces, with their specific shape corresponding to the shape (e.g., oscillation) of the ridge. As shown in the example, the first side surface 526 and the second side surface 528 are provided as undulating surfaces (e.g., a wave shape). This contour of the undulating surface is schematically illustrated by the lines shown on the second side surface 526 in FIG. 17.

The ridge 530 exemplified in FIGS. 16-18 is provided as a non-linear, winding path having three oscillations with a given amplitude A. The period P (frequency) and/or the amplitude A at which the ridge oscillates may be set to any appropriate value. As an example, the overall length of the serpentine-shaped micro-optical element may be set to a value between about 500 μm and 1000 μm, and the period P (frequency) and the amplitude A may be set accordingly. In other embodiments, the overall length of the serpentine-shaped micro-optical element may be set to a larger or smaller value than between about 500 μm and 1000 μm. The micro-optical element may include a larger or smaller number of oscillations depending on its length and the value of the period P.

In some embodiments, the period P may range from about 10 μm to about 500 μm. In another example, the period P may range from about 50 μm to about 250 μm. In another example, the period P may range from about 75 μm to about 225 μm. If the period P is too large (too low of a frequency), the serpentine shape may not provide an effective reduction in one or more of the above-mentioned undesirable visual effects. If the period P is too low (too high a frequency), the shape may degrade the directional, specular light output distribution of the light output from the lighting assembly. In some embodiments, the amplitude A may range from about 1 μm to about 100 μm. In another example, the amplitude may range from about 5 μm to about 50 μm. In another example, the amplitude may range from about 10 μm to about 25 μm. If the amplitude A is too low, the serpentine shape may not provide an effective reduction in one or more of the above-mentioned undesirable visual effects. If the amplitude A is too high, the shape may degrade the directional, specular light output distribution of the light output from the lighting assembly. It will be appreciated that the period P (frequency) and amplitude A selected for a given light extracting element may depend in part on one another. For example, a smaller period (higher frequency) may allow for the amplitude to be lower. In another example, a larger period (lower frequency) may allow for the amplitude to be higher. Of course, it will be appreciated that in some embodiments the period and amplitude may still be selected to have a relatively high period and a relatively high amplitude; and/or may be selected to have a relatively low period and a relatively low period.

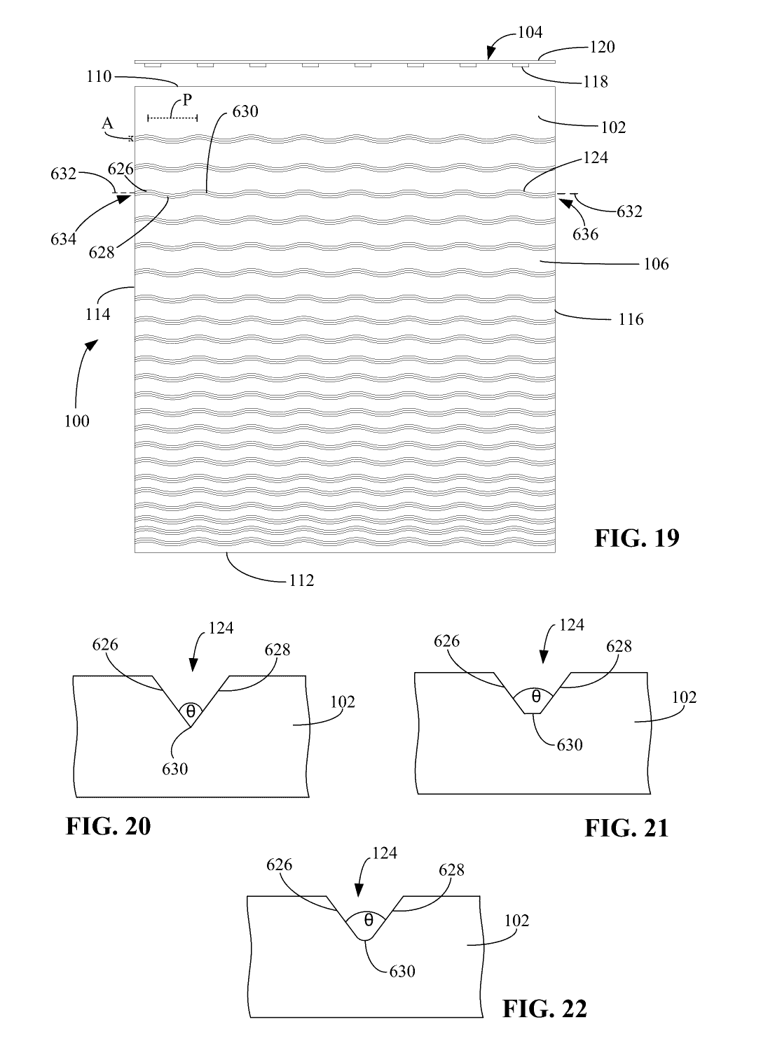

In the exemplary embodiments described above and shown in FIGS. 5-7, 10-12, 13-15, and 16-18, the respective serpentine-shaped light extracting elements are embodied as micro-optical elements. In other embodiments, the serpentine-shaped light extracting element may be configured as a different light extracting element of well-defined shape. FIGS. 19-22 show exemplary embodiments of a lighting assembly that include light extracting elements 124 embodied as v-grooves or truncated v-grooves, with FIGS. 20-22 specifically showing different exemplary embodiments of the ridge or end surface that may be included as part of the groove. FIG. 19 shows a top view of the lighting assembly as viewed from a direction orthogonal to the major surface at which the light extracting elements are formed. FIGS. 20-22 respectively show side cross-sectional views of exemplary light extracting elements with their longitudinal axes normal to the plane of the page.

With specific reference to FIGS. 19 and 20, the exemplary serpentine-shaped light extracting element may be embodied as a v-shaped depression (v-groove) in the major surface having a ridge 630 that extends in a non-linear, winding path as viewed from a direction orthogonal to the major surface at which the light extracting element is formed between the first end 634 and the second end 636 of the v groove (shown in FIG. 19). With reference to FIG. 20, the serpentine-shaped light extracting element 124 includes a first side surface 626 and a second side surface 628 that each extend from the major surface, and that come together (intersect) to form the ridge 630.

With specific reference to FIGS. 19 and 21, the exemplary serpentine-shaped light extracting element may be embodied as a v-shaped depression (truncated v-groove) in the major surface having an end surface 630 that extends in a non-linear, winding path as viewed from a direction orthogonal to the major surface at which the light extracting element is formed between the first end 634 and the second end 636 of the v-groove (shown in FIG. 19). With reference to FIG. 21, the serpentine-shaped light extracting element 124 includes a first side surface 626 and a second side surface 628 that extend from the major surface, and that are connected to each other by the end surface 630. When viewed in cross-section along the longitudinal axis and normal to the thickness direction (FIG. 21), the end surface 630 is shown as a planar surface.

With specific reference to FIGS. 19 and 22 the exemplary serpentine-shaped light extracting element may be embodied as a v-shaped depression (truncated v-groove) in the major surface having an end surface 630 that extends in a non-linear, winding path as viewed from a direction orthogonal to the major surface at which the light extracting element is formed between the first end 634 and the second end 636 of the v groove (shown in FIG. 19). With reference to FIG. 22, the serpentine-shaped light extracting element 124 includes a first side surface 626 and a second side surface 628 that extend from the major surface, and that are connected to each other by the end surface 630.

When viewed in cross-section along the longitudinal axis and normal to the thickness direction (FIG. 22), the end surface 630 is shown as an arcuate surface.

For each of the respective embodiments exemplified in FIGS. 19-22, the included angle θ formed between the first side surface 626 and the second side surface 628 may be any suitable angle, and may be set for extracting light from the light guide 102 at a defined intensity profile and/or light ray angle distribution. As an example, the included angle θ may range from 30 degrees to 165 degrees. In some embodiments, the first side surface 626 and the second side surface 628 are symmetric relative to a plane extending parallel to the longitudinal axis 632 and extending normal to the major surface. In other embodiments, the first side surface 626 and the second side surface 628 are asymmetric relative to a plane extending parallel to the longitudinal axis 632 and extending normal to the major surface.

For each of the respective embodiments shown in FIGS. 19-22, the longitudinal axis 632 of the serpentine-shaped light extracting element extends between the first end 634 and the second end 636 of the v-groove/truncated v-groove. The ridge/end surface 630 extends along the longitudinal axis 632 between the first end 634 and the second end 636 of the light extracting element. As shown in FIG. 19 from the top view of the exemplary light extracting element, as viewed from a direction orthogonal to the major surface at which the light extracting element is formed, the ridge/end surface 630 oscillates in a sinusoidal pattern with a given period P (frequency) and amplitude A between the first end 634 and the second end 636 of the micro-optical element. As a result of the oscillation of the ridge/end surface 630, the first side surface 626 and the second side surface 628 are also non-planar surfaces, with their specific shape corresponding to the shape (e.g., oscillation) of the ridge/end surface 630. As shown in the example, the first side surface 626 and the second side surface 628 are provided as undulating surfaces (e.g., a wave shape).

The period P (frequency) and/or the amplitude A at which the ridge/end surface 630 oscillates may be set to any appropriate value. In some embodiments, the period P may range from about 10 μm to about 500 μm. In another example, the period P may range from about 50 μm to about 250 μm. In another example, the period P may range from about 75 μm to about 225 μm. If the period P is too large (too low of a frequency), the serpentine shape may not provide an effective reduction in one or more of the above-mentioned undesirable visual effects. If the period P is too low (too high a frequency), the shape may degrade the directional, specular light output distribution of the light output from the lighting assembly. In some embodiments, the amplitude A may range from about 1 μm to about 100 μm. In another example, the amplitude may range from about 5 μm to about 50 μm. In another example, the amplitude may range from about 10 μm to about 25 μm. If the amplitude A is too low, the serpentine shape may not provide an effective reduction in one or more of the above-mentioned undesirable visual effects. If the amplitude A is too high, the shape may degrade the directional, specular light output distribution of the light output from the lighting assembly. It will be appreciated that the period P (frequency) and amplitude A selected for a given light extracting element may depend in part on one another. For example, a smaller period (higher frequency) may allow for the amplitude to be lower. In another example, a larger period (lower frequency) may allow for the amplitude to be higher. Of course, it will be appreciated that in some embodiments the period and amplitude may still be selected to have a relatively high period and a relatively high amplitude; and/or may be selected to have a relatively low period and a relatively low period.

In the embodiments described with respect to FIGS. 19-22, the ridge or end surface of the groove may be linear as viewed from a direction orthogonal to the thickness direction of the light guide and orthogonal to the longitudinal axis. In other embodiments, the ridge or end surface of the groove may have an arcuate or dragged shape as viewed from a direction orthogonal to the thickness direction and orthogonal to the longitudinal axis. In still other embodiments, the ridge or end surface of the groove may have another suitable configuration as viewed from a direction orthogonal to the thickness direction and orthogonal to the longitudinal axis. As an example, at least a portion of the ridge or end surface as viewed from a direction orthogonal to the thickness direction and orthogonal to the longitudinal axis may extend in a non-linear, winding path. In some embodiments, the ridge or surface may undulate as viewed from a direction orthogonal to the thickness direction and orthogonal to the longitudinal axis. For example, in some embodiments, at least a portion of the ridge or end surface as viewed from a direction orthogonal to the thickness direction and orthogonal to the longitudinal axis may be provided in a sinusoidal path such that it oscillates in a sinusoidal pattern.

In the exemplary embodiments described above, the serpentine-shaped light extracting elements are shown as planar/linear surfaces as viewed in cross-section from a direction orthogonal to the thickness direction and parallel to the longitudinal axis. For example, FIGS. 7, 12, 15, 18 and 20-22, which each show a side cross-sectional view of the light extracting element 124 with the longitudinal axis of the light extracting element normal to the plane of the page, each show the light extracting element as having planar linear first and second side surfaces. In other embodiments, one or more of the first and second side surfaces has a curvature about a direction (e.g., an axis) extending in a plane parallel to the major surface of the light guide (or about a direction extending along a surface contour of the major surface of a non-planar light guide). In some embodiments, this direction about which the surface curves is parallel to the longitudinal axis of the light extracting element. The term “curvature,” when used herein to refer to the curvature of a surface of the light extracting element about a direction extending in a plane parallel to the major surface of the light guide (or about a direction extending along a surface contour of the major surface of a non-planar light guide), is defined as a change in angle of the surface of the light extracting element relative to the normal to the major surface along the surface of the light extracting element as the surface extends from the major surface. Curvature about a direction extending in a plane parallel to the major surface of the light guide (or about a direction extending along a surface contour of the major surface of a non-planar light guide) is contrasted with a curved shape of a light extracting element when viewed from a direction orthogonal to the major surface of the light guide.

In the exemplary embodiments described above, the serpentine-shaped light extracting elements are shown as extending along a longitudinal axis between a first end and a second end, wherein the longitudinal axis extends linearly. In some of these embodiments, at least a portion of the ridge or end surface may undulate (e.g., oscillate in a sinusoidal pattern) relative to the longitudinal axis as viewed from a direction orthogonal to the major surface. In other embodiments, at least a portion of the serpentine-shaped light extracting element may extend along a curve between a first end and a second end of the serpentine-shaped light extracting element. In such embodiments, the longitudinal axis may be regarded as a curved longitudinal axis (or as a longitudinal curve). Accordingly, while the light extracting element may be defined herein as having a longitudinal axis, it will be understood that embodiments of the longitudinal axis may include a curve as viewed from a direction orthogonal to the major surface. The ridge or end surface may undulate (e.g., oscillate in a sinusoidal pattern) relative to the curve as viewed from a direction orthogonal to the major surface. As an example, while the grooves shown in FIG. 19 extend linearly as viewed from a direction orthogonal to the major surface, other embodiments of the groove may be curved and oriented in a concentric or radial arrangement relative to a given center point. In such example, the respective ridges and/or end surfaces may undulate (e.g., oscillate in a sinusoidal pattern) relative to the curve (e.g., a curved longitudinal axis) as viewed from a direction orthogonal to the major surface. In the embodiments where the grooves are concentric (e.g., circles), the first and second ends of a respective groove may be located at the same position (e.g., in order to form the circular shape). In other examples, the light extracting elements embodied as micro-optical elements may extend along a curve (e.g., a curved longitudinal axis) between a first end and a second end of the serpentine-shaped light extracting element, and the ridge or end surface may undulate (e.g., oscillate in a sinusoidal pattern) relative to the curve as viewed from a direction orthogonal to the major surface.

In the exemplary embodiments of the light extracting element described above including an end surface, the end surface may be planar or arcuate as viewed from a direction orthogonal to the thickness direction and orthogonal to the longitudinal axis. For example, FIGS. 12 and 21 each show a planar end surface as viewed from a direction orthogonal to the thickness direction and orthogonal to the longitudinal axis, and FIGS. 15 and 22 each show an arcuate end surface as viewed from a direction orthogonal to the thickness direction and orthogonal to the longitudinal axis. In other embodiments, the end surface may be another suitable shape. Exemplary shapes of the end surface as viewed from a direction orthogonal to the thickness direction and orthogonal to the longitudinal axis include a convex or concave shape, an undulating shape, a jagged shape, or another suitable shape.

As described above, the serpentine-shaped light extracting elements may be included in an array of light extracting elements 124 provided at the major surface(s) of the light guide. The light extracting elements 124 may be arranged in any suitable manner to extract light in a defined intensity profile (e.g., a uniform intensity profile) and with a defined light ray angle distribution from one or both of the major surfaces 106, 108.

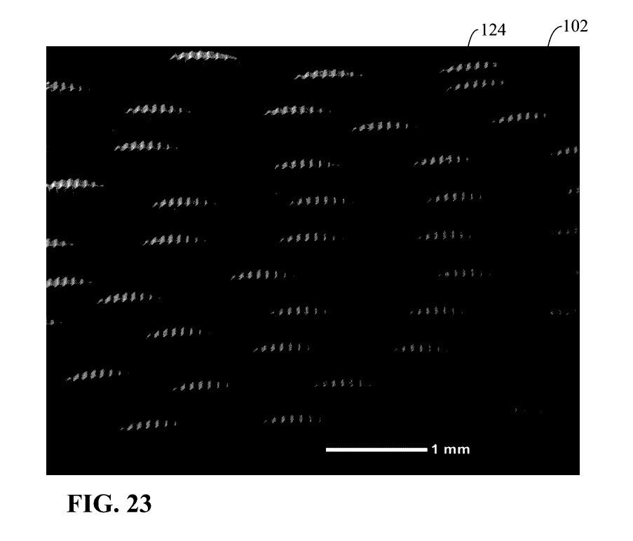

In some embodiments, the light extracting elements 124 provided at the major surface have the same or nominally the same shape, size, depth, height, slope angle, included angle, surface roughness, orientation, and/or index of refraction. As an example, each of the light extracting elements 124 may have the same or nominally the same serpentine-shaped micro-optical element described in one of the above embodiments. For example, the micro-optical elements generically shown as dashes in FIG. 1 may each be embodied as a serpentine-shaped micro-optical element such as that shown in FIG. 5. FIG. 23 shows an SEM image of part of an exemplary light guide in which the light extracting elements are each provided as having nominally the same serpentine micro-optical element shape. In another example, and with exemplary reference to FIG. 19, the light extracting elements may each be provided as grooves (e.g., v-groove or truncated v-groove) having nominally the same shape.

In other embodiments, the light extracting elements may vary in one or more of shape, size, depth, height, slope angle, included angle, surface roughness, orientation, and/or index of refraction. This variation in light extracting elements may achieve a desired light output from the light guide over the corresponding major surface(s).

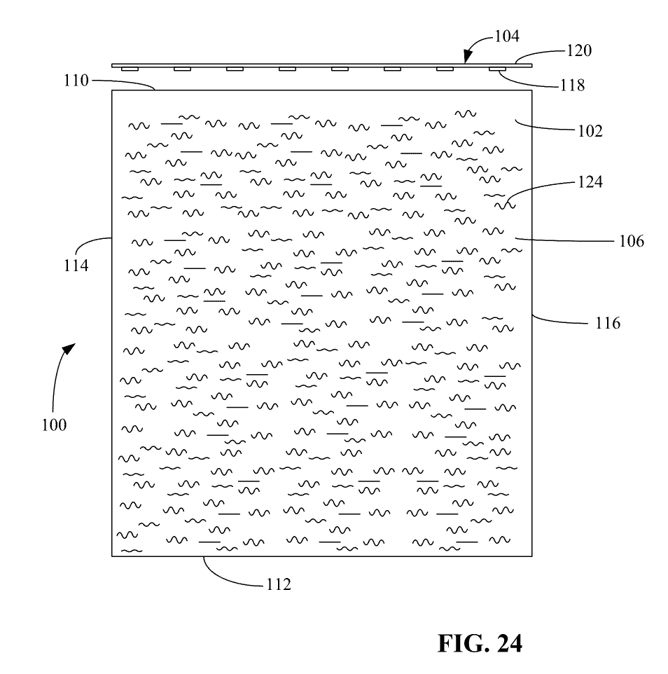

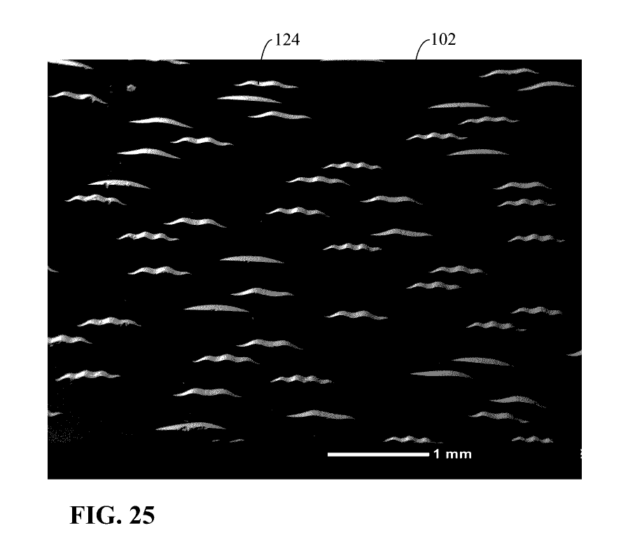

As an example, FIG. 24 is a schematic top view of exemplary lighting assembly including a light guide having several different shapes of light extracting elements at its major surface. The major surface 106 of the light guide 102 includes multiple types of serpentine-shaped micro-optical elements, and also includes non-serpentine-shaped micro-optical elements. The different shaped micro-optical elements are shown as being nominally homogeneously mixed throughout the major surface. FIG. 25 is an SEM image of part of an exemplary light guide in which different shaped micro-optical elements are intermixed as shown in FIG. 24.

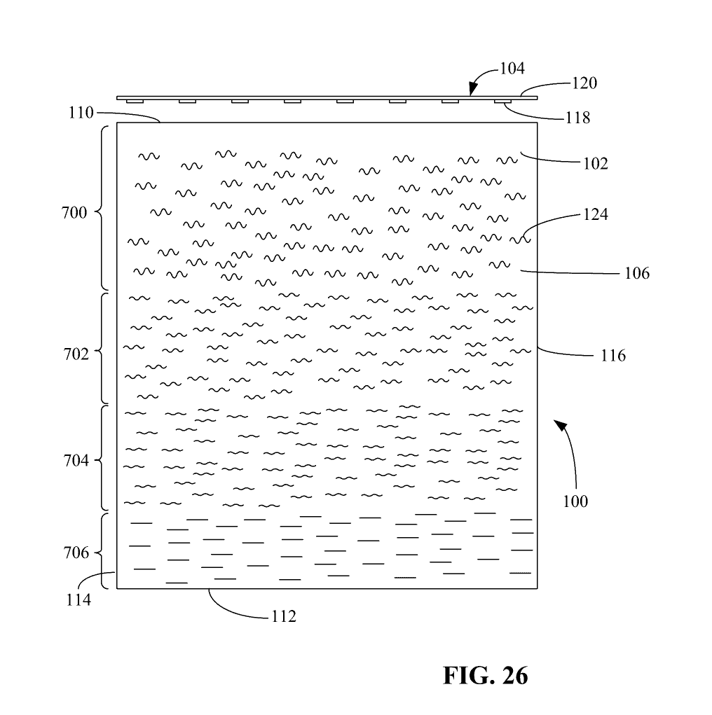

As another example, FIG. 26 is a schematic top view of an exemplary lighting assembly including a light guide having several different shapes of light extracting elements at its major surface. The micro-optical elements shown at the major surface 106 are segregated by type at different regions of the light guide. In this exemplary embodiment, the micro-optical elements differ in amplitude. At the first region 700 closest to the light input edge 110, the micro-optical elements are provided as having a serpentine shape with a first amplitude. At the second region 702 further from the light input edge 110 than the first region 700, the micro-optical elements are provided as having a serpentine shape with a second amplitude smaller than the first amplitude. At the third region 704 further from the light input edge 110 than the first region 700 and the second region 702, the micro-optical elements are provided as having a serpentine shape with a third amplitude smaller than the first amplitude and the second amplitude. At the fourth region 706 further from the light input edge 110 than the first region 700, second region 702, and third region 704, the micro-optical elements have no amplitude such that they are non-serpentine-shaped micro-optical elements. In other examples not specifically shown, this reduction in a property with distance from the light input edge may apply to one or more other features of the light extracting elements, such as the period length, size, and/or the number of oscillations. This reduction in a property with distance from the light input edge may also apply to embodiments where the light extracting elements are embodied as grooves (e.g., v-grooves or truncated v-grooves).

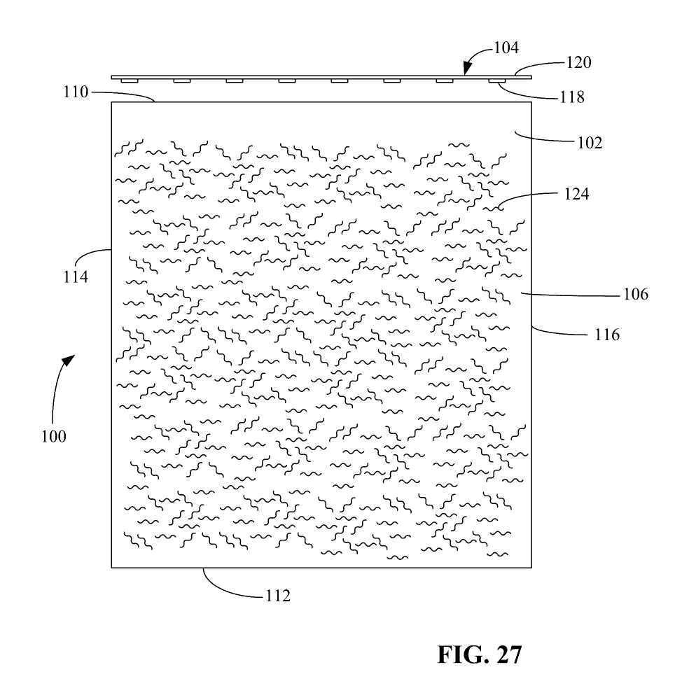

As exemplified by embodiments described above, in some embodiments the longitudinal axes of the light extracting element are arranged such that their longitudinal axes are nominally parallel to the light input edge. In other embodiments, the longitudinal axes of the light extracting elements are arranged with their longitudinal axes within the range of angles +θ° relative to the light input edge. A portion of the micro-optical elements may be respectively arranged with the longitudinal axes thereof parallel or nominally parallel to the light input edge, and a portion of the micro-optical elements may be respectively arranged with the longitudinal axes thereof non-parallel to the light input edge. For example, FIG. 27 is a schematic top view of exemplary lighting assembly including a light guide having light extracting elements arranged at different angles relative to the light input edge 110. In the example shown, the longitudinal axes of the micro-optical elements are arranged within the range of +45° to −45° relative to the light input edge. In other embodiments, the longitudinal axes of the micro-optical elements are arranged within the range of +30° to −30° relative to the light input edge. In other embodiments, the longitudinal axes of the micro-optical elements are arranged within the range of +15° to −15° relative to the light input edge. Rotation of the light extracting elements may help to further reduce the above-described undesirable visual effects.

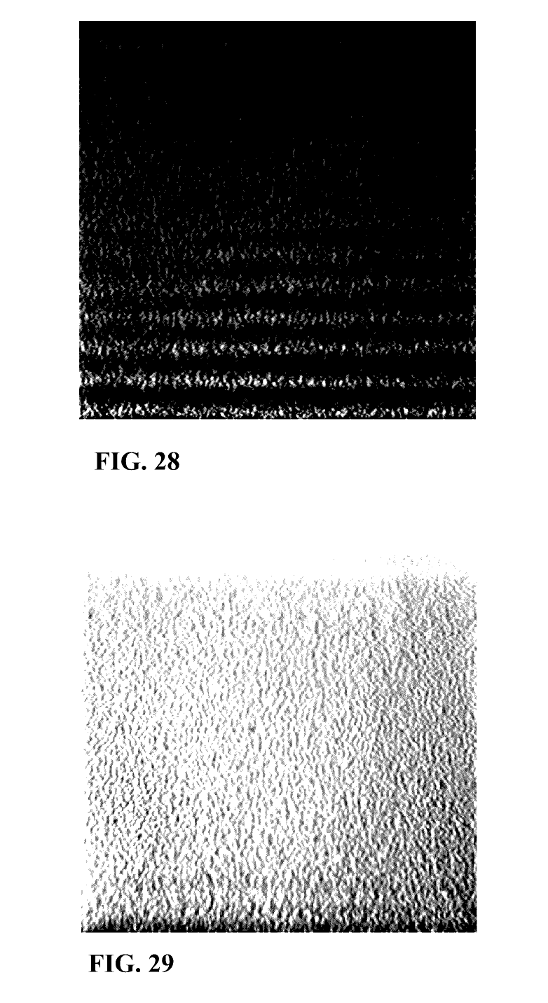

FIGS. 28 and 29 exemplify a reduction in banding that may be observed at a major surface of a light guide through the use of the serpentine-shaped light extracting elements. For each of FIGS. 28 and 29, the associated lighting assembly is similar to the lighting assembly 100 shown in FIG. 1 in that it includes a light guide 102 that is edge lit using a light source 104, and the light guide 102 includes light extracting elements at the major surface. For FIG. 28, the light guide includes an array of specular football-shaped micro-optical elements at its major surface (similar to that shown in FIGS. 2-4). The micro-optical elements are arranged such that each of their longitudinal axes is within the range of +45° to −45° relative to the light input edge of the light guide (similar to the rotated arrangement discussed with respect to FIG. 27). As shown in FIG. 28, a banding effect is observed when viewing the major surface.

For FIG. 29, the light guide includes an array of serpentine-shaped micro-optical elements. In the embodiment shown in FIG. 8, the micro-optical elements are arranged such that each of their longitudinal axes is within the range of +45° to −45° relative to the light input edge of the light guide. Each of the serpentine-shaped micro-optical elements is similar in shape to that shown in FIGS. 5-7, and has a period of about 140 μm and an amplitude of about 20 μm. FIG. 29 shows a reduction in banding as compared with that shown in FIG. 28.

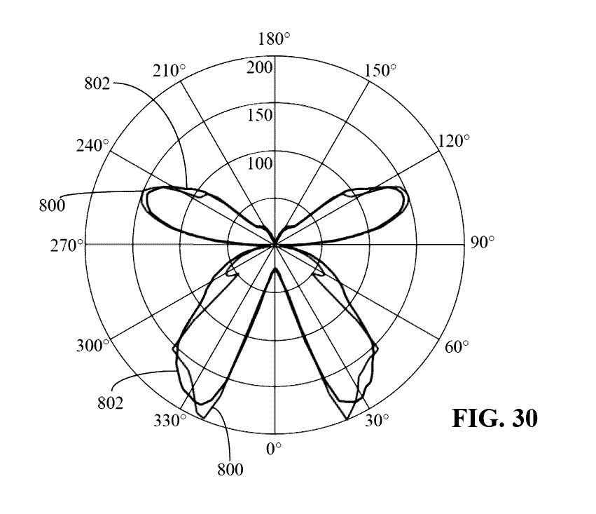

FIGS. 30 exemplifies that the light output distribution may also be largely maintained when the serpentine-shaped light extracting elements are used in place of non-serpentine-shaped micro-optical elements. More specifically, FIG. 30 illustrates the comparison of light output distributions showing far-field light ray angle distributions of light extracted from exemplary lighting assemblies. For purposes of FIG. 30, the lighting assembly is similar to the lighting assembly 100 shown in FIG. 1 but includes an additional light source at the edge surface 112. The result of two different light guides is shown with respect to FIG. 30: the first is a light guide including an array of specular football-shaped micro-optical elements (similar to that shown in FIGS. 2-4), the micro-optical elements being arranged such that each of their longitudinal axes is within the range of +45° to −45° relative to the light input edge of the light guide; and the second is a light guide including an array of serpentine-shaped micro-optical elements (similar to that shown in FIGS. 5-7), the micro-optical elements arranged such that each of their longitudinal axes is within the range of +45° to −45° relative to the light input edge of the light guide. In FIG. 30, the light output distribution 800 corresponds to the light guide including the array of specular football-shaped micro-optical elements, and the light output distribution 802 corresponds to the light output distribution of the light guide including the array of serpentine-shaped micro-optical elements.

The degree scale shown in FIG. 30 represents an azimuth relative to the normal of the major surface 106, 108. The output distribution profile shows the light distribution (vertical beam angle) in a plane orthogonal to the light input edge 110 and to the major surfaces 106, 108 of the light guide 102. For this distribution, the light source 104 is arranged adjacent the light input edge 110 proximate 90°, the additional light source is arranged adjacent the edge surface 112 proximate 270°, the major surface 106 is arranged proximate 180°, and the major surface 108 is arranged proximate 0°. As shown, the light output distribution is largely maintained when the serpentine-shaped micro-optical elements are used in place of the non-serpentine-shaped micro-optical elements.

FIG. 31 shows another exemplary embodiment of a lighting assembly at 200. The lighting assembly 200 is similar to the lighting assembly 100 shown in FIG. 1, but includes a cover element 260 located adjacent a major surface of the light guide 102. In the embodiment shown, light extracted from the light guide 102 (via light extracting elements) may be incident the cover element 260. The light extracting elements at the major surface of the light guide may include non-serpentine-shaped light extracting elements, serpentine-shaped light extracting elements, or a mixture of non-serpentine-shaped light extracting elements and serpentine-shaped light extracting elements.

The cover element 260 may be a solid article of manufacture (e.g., a substrate) made from, for example, polycarbonate, poly(methyl-methacrylate) (PMMA), glass, or other appropriate material; and may include a first major surface 262 and a second major surface 264 opposite the first major surface. With additional reference to FIG. 32, at least one edge surface extends between the major surfaces 262, 264 of the cover element (e.g., in the thickness direction 119). The total number of edge surfaces depends on the configuration of the cover element 260. The configuration of the cover element may correspond to the configuration of the light guide such that a major surface of the cover element conforms to the shape of the adjacent major surface of the light guide. For example, in the case where the light guide is rectangular, the cover element 260 may also be rectangular with four edge surfaces 266, 268, 270, 272. In the embodiment shown in FIG. 31, the major surfaces 262, 264 of the cover element are planar. In other embodiments, at least a portion of the major surfaces 262, 264 of the cover element is curved in one or more directions. In one example, the intersection of the edge surface 266 and one of the major surfaces 262, 264 defines a first axis, and at least a portion of the cover element curves about an axis parallel to the first axis. In another example, at least a portion of the cover element curves about an axis orthogonal to the first axis. The first major surface 262 of the cover element 260 may not be optically coupled with the first major surface 106 of the light guide 102 in order to avoid extracting light from the light guide 102 with the cover element 260. As shown, in some embodiments, the light guide 102 and the cover element 260 are separated by an air gap.

The cover element may include light redirecting elements 224 configured to redirect light passed through the cover element. Light emitted from the edge lit light guide may further be redirected by the light redirecting elements 224 of the cover element 260. As an example, in some embodiments, the cover element 260 is configured to redirect high angle light to have a reduced angle of travel in the thickness direction 119. With specific reference to FIG. 32, the cover element 260 may include serpentine-shaped light redirecting elements 124. As shown, the light redirecting elements may be arranged in an overlapping manner. The longitudinal axes 732 of the respective light redirecting elements may be arranged at different angles relative to one another, and a given light redirecting element may overlap one or more differently-oriented light redirecting elements 732. In other embodiments, the light redirecting elements may be arranged in a non-overlapping manner.

Similar to the light extracting elements described above, the light redirecting elements of the present disclosure are referred to herein as “serpentine-shaped” because the ridge or surface 730 extending along the longitudinal axis 732 of the element between its first end 734 and second end 736 extends in a non-linear, winding path as viewed from a direction orthogonal to the major surface of the cover element at which the light redirecting element is formed. In some embodiments, the ridge or surface may be defined as extending in an undulate manner as viewed from a direction orthogonal to the major surface. For example, in some embodiments, the ridge or surface is provided in a sinusoidal path such that it oscillates in a sinusoidal pattern as viewed from a direction orthogonal to the major surface. In an example, the ridge or surface may oscillate in a sinusoidal pattern with a given frequency and amplitude that is nominally constant and uniform from the first end to the second end of the light extracting element. In another example, the oscillation varies in one or both of frequency and amplitude between the first end and the second end of the light extracting element. For example, the oscillation may increase and/or decrease in one or both of frequency and amplitude. In still another example, the ridge or surface may oscillate for a portion of the distance between the first end and the second end of the micro-optical element, while one or more other portions of the distance between the first end and the second end of the micro-optical element may be linear. Hence, the ridge may be partially sinusoidal and partially linear, pseudo-random, or any other suitable shape.

The specific shape(s) and parameters of the serpentine-shaped light redirecting elements 224 may be similar to the shapes of the light extracting elements 124 described in connection with FIGS. 5-7, 10-12, 13-15, 16-18, and 19-22. For the sake of brevity, the description of such shapes in the context of a serpentine-shaped light redirecting element will not be repeated, but may equally apply in the context of the cover element.

In some embodiments, the length of the light redirecting element 224 may be longer than the serpentine-shaped light extracting elements embodied as micro-optical elements. In an example, a light redirecting element may be about 2 mm to about 6 mm in length. In another example, the light redirecting element may be about 3 mm to about 5 mm in length. But regardless of the specific length, the light redirecting element may have similar parameters regarding the period and amplitude of the ridge or end surface to the parameters described above with respect to the light extracting elements 124.

The serpentine-shaped light redirecting elements 224 may be included in the array of light redirecting elements provided at the major surface(s) of the cover element 260. A portion or all of the light redirecting elements at the major surface(s) may be serpentine-shaped light extracting elements. The presence of the sepentine-shaped light redirecting elements 224 in the array may reduce undesired visual effects associated with the lighting assembly. For example, a reduction in color splitting with light emitted from a cover element may be observed through the use of the serpentine-shaped micro-optical elements at the major surface of the cover element. By including serpentine-shaped light redirecting elements, the preservation of output angle to input angle can be reduced or eliminated. At the same time, precise control over the output may be retained since the output angle of a specific input angle may still vary in a predictable, controllable fashion across the light redirecting element 224 based on the location that the interaction occurs at the serpentine-shaped pattern of the light redirecting element.

Light guides having light extracting elements and cover elements having light redirecting elements are typically formed by a process such as injection molding. The light extracting elements are typically defined in a shim or insert used for injection molding light guides by a process such as diamond machining, laser micromachining, photolithography, or another suitable process. Alternatively, any of the above-mentioned processes may be used to define the light extracting elements in a master that is used to make the shim or insert. In other embodiments, light guides without light extracting elements are typically formed by a process such as injection molding or extruding, and the light extracting elements are subsequently formed on one or both of the major surfaces by a process such as stamping, embossing, or another suitable process.

One exemplary method of producing the above-described serpentine-shaped light extracting elements and the above-described serpentine-shaped light redirecting elements is by use of a patterning tool. The patterning tool is typically embodied as a solid article made from, for example, metal, acrylic, polycarbonate, PMMA, or other appropriate material. As an example, the patterning tool may be embodied as a linear cutting tool having a first machining edge configured to cut a surface that defines first side surface of the light extracting/redirecting element, and a second machining edge configured to cut a surface that defines the second surface of the light extracting/redirecting element. In some embodiments of the linear cutting tool, an intersection of the first machining edge and the second machining edge at an end of the machining element is configured to define the ridge of the light extracting/redirecting element. In other embodiments of the linear cutting tool, a third machining edge is configured to cut a surface that defines the end surface of the light extracting/redirecting element.

The patterning tool may couple to an apparatus (e.g., a CNC lathe) for conducting the machining of a substrate, such as the light guide, cover element, shim/insert, or master. When cutting the substrate at a specified depth or depth profile, the linear cutting tool may be moved in a longitudinal direction at the surface of the substrate (e.g., parallel to the longitudinal axis of the light extracting/redirecting element). During movement in the longitudinal direction, the linear cutting tool may also be moved in the lateral direction (orthogonal to the longitudinal direction) at a period (frequency) and amplitude that may provide for the oscillation shown in the figures depicting the serpentine-shaped light extracting elements and serpentine-shaped light redirecting elements. The depth (depth profile) at which the tool cuts (e.g., in the thickness direction) may define the arcuate shape of the ridge or top surface, and the depth may be controlled to produce, for example, a dragged shape or other suitable shape.

The element produced by the patterning tool, if produced at the major surface of a substrate such as a shim/insert or master (instead of being directly produced at the major surface of a substrate such as a light guide or cover element), may generically be referred to as an element of well-defined shape, and may have the configuration and/or dimensions of one or more of the exemplary above-described serpentine-shaped light extracting elements and the above-described serpentine-shaped light redirecting elements.

In this disclosure, the phrase “one of” followed by a list is intended to mean the elements of the list in the alterative. For example, “one of A, B and C” means A or B or C. The phrase “at least one of” followed by a list is intended to mean one or more of the elements of the list in the alterative. For example, “at least one of A, B and C” means A or B or C or (A and B) or (A and C) or (B and C) or (A and B and C).

What is claimed is:

1. A light guide, comprising:
a first major surface;
a second major surface opposed the first major surface;
a light input edge extending between the first major surface and the second major surface, the first major surface and the second major surface configured to propagate light input to the light guide through the light input edge therebetween by total internal reflection; and
light extracting elements at at least one of the major surfaces, at least a portion of the light extracting elements comprising:
a longitudinal axis extending between a first end and a second end of the light extracting element;
a first side surface and a second side surface each extending from the major surface of the light guide at which the light extracting element is formed; and
a ridge or end surface connecting the first side surface and the second side surface, the ridge or end surface extending along the longitudinal axis in a non-linear, winding path as viewed from a direction orthogonal to the major surface of the light guide at which the light extracting element is formed.

2. The light guide of claim 1, wherein the ridge or end surface oscillates in a sinusoidal pattern with a given period and amplitude as viewed from the direction orthogonal to the major surface of the light guide at which the light extracting element is formed.

3. The light guide of claim 2, wherein the oscillation is nominally constant and uniform from the first end to the second end of the light extracting element.

4. The light guide of claim 2, wherein the oscillation varies in one or both of the period and the amplitude between the first end and the second end of the light extracting element.

5. The light guide of claim 2, wherein
the ridge or end surface of one of the light extracting elements has a first period and a first amplitude; and
the ridge or end surface of another of the light extracting elements has a second period and a second amplitude, wherein one or both of the second period and the second amplitude is different than the first period and the first amplitude, respectively.

6. The light guide of claim 1, wherein the at least a portion of the light extracting elements are micro-optical elements and the ridge or end surface has ends that respectively intersect the major surface of the light guide at which the micro-optical element is formed at the first end and the second end of the micro-optical element.

7. The light guide of claim 6, wherein the micro-optical elements comprise the ridge, the first side surface and a second side surface intersecting to form the ridge.

8. The light guide of claim 6, wherein the micro-optical elements comprise the end surface.

9. The light guide of claim 8, wherein the end surface of the light extracting element viewed in cross-section along the longitudinal axis and normal to a thickness direction extending between the first major surface and the second major surface of the light guide is a planar surface.

10. The light guide of claim 8, wherein the end surface of the light extracting element viewed in cross-section along the longitudinal axis and normal to a thickness direction extending between the first major surface and the second major surface of the light guide is an arcuate surface.

11. The light guide of claim 1, wherein the at least a portion of the light extracting elements are grooves.

12. The light guide of claim 11, wherein the grooves comprise the ridge, the first side surface and a second side surface intersecting to form the ridge.

13. The light guide of claim 11, wherein the grooves comprise the end surface.

14. The light guide of claim 13, wherein the end surface viewed in cross-section along the longitudinal axis and normal to a thickness direction extending between the first major surface and the second major surface of the light guide is a planar surface.

15. The light guide of claim 13, wherein the end surface viewed in cross-section along the longitudinal axis and normal to a thickness direction extending between the first major surface and the second major surface of the light guide is an arcuate surface.

16. A lighting assembly, comprising:
the light guide of claim 1; and
a light source adjacent the light input edge of the light guide and configured to edge light the light guide.

17. A micro-optical element formed at a major surface of a light guide, comprising:
a longitudinal axis extending between a first end and a second end of the micro-optical element;
a first side surface and a second side surface each extending from the major surface of the light guide at which the micro-optical element is formed; and
a ridge or end surface connecting the first side surface and the second side surface, the ridge or end surface having ends that respectively intersect the major surface of the light guide at the first end and the second end of the micro-optical element, the ridge or end surface extending along the longitudinal axis in a non-linear, winding path as viewed from a direction orthogonal to the major surface of the light guide at which the light extracting element is formed.

18. The micro-optical element of claim 17, wherein the ridge or end surface oscillates in a sinusoidal pattern with a given period and amplitude as viewed from the direction orthogonal to the major surface of the light guide at which the light extracting element is formed

19. A lighting assembly, comprising:
a light guide having opposed first and second major surfaces between which light propagates by total internal reflection, the light guide comprising light extracting elements configured to output light from the light guide; and
a cover element adjacent one of the major surfaces of the light guide and configured to redirect light output from the light guide, the cover element comprising:
a first major surface;
a second major surface opposed to the first major surface; and
light redirecting elements at at least one of the major surfaces of the cover element, at least a portion of the light redirecting elements comprising:
a longitudinal axis extending between a first end and a second end of the light redirecting element;
a first side surface and a second side surface each extending from the major surface of the cover element at which the light redirecting element is formed; and
a ridge or end surface connecting the first side surface and the second side surface, the ridge or end surface extending along the longitudinal axis in a non-linear, winding path as viewed from a direction orthogonal to the major surface of the cover element at which the light redirecting element is formed.

20. The lighting assembly of claim 19, wherein the ridge or surface oscillates in a sinusoidal pattern with a given period and amplitude as viewed from a direction orthogonal to the major surface of the cover element at which the light redirecting element is formed.
